(19) United States
(12) Patent Application Publication
(10) Pub. No.: US 2025/0285470 A1
(43) Pub. Date: Sep. 11, 2025

(54) DYNAMIC ATTENTION OR EMOTIONAL-STATE FEEDBACK

(71) Applicant: AboutFace LLC, San Clemente, CA (US)

(72) Inventor: Joseph Richard Weatherbee, San Clemente, CA (US)

(21) Appl. No.: 19/072,914

(22) Filed: Mar. 6, 2025

Related U.S. Application Data
(60) Provisional application No. 63/562,213, filed on Mar. 6, 2024.

(51) Int. Cl. G06V 40/20; G06V 20/00; G06V 40/16

(52) U.S. Cl. CPC G06V 40/20; G06V 20/35; G06V 40/174

(57) ABSTRACT

An electronic device may receive (or access) images, as a function of time, of a group of individuals in an environment. Then, the electronic device may dynamically determine attention or an indicia of an emotional state of individuals in the group of individuals based at least in part on nonverbal communication by the group of individuals in the images. Moreover, the electronic device may dynamically aggregate a subset of the group of individuals having a particular determined attention or indicia. Next, the electronic device may provide information corresponding to the subset of the group of individuals having the particular determined attention or indicia. In some embodiments, the electronic device may identify a culture of at least a subset of the group of individuals, and the dynamic determined attention or emotional state may be based at least in part on the identified culture.

### FIELD

The described embodiments relate to providing feedback about a dynamically determined attention or emotional state of one or more individuals.

### BACKGROUND

While video conferencing offers notable convenience and has grown in popularity, it often fails to replicate the nuances of in-person interactions. In particular, screen-based communication makes it difficult to perceive the rich, often unspoken dynamics between participants. This challenge becomes more pronounced in larger groups, where reading facial expressions, affect, and body language of all individuals is impractical, especially as subgroups form and engage in non-verbal exchanges. As a result, users frequently find it difficult and frustrating to interact effectively in virtual meetings, particularly in large or diverse groups. These limitations of existing video conferencing platforms contribute to user dissatisfaction.

Similar challenges can also arise in face-to-face interactions involving multiple individuals. For instance, individuals with cognitive diversity or neurodiversity, such as those with autism spectrum disorder (ASD), often find it difficult to interpret facial expressions, which can lead to confusion, isolation, and misunderstandings in social settings. This difficulty extends to both literal and figurative aspects of “reading the room.” Neurological and perceptual differences can make it challenging for individuals with ASD to engage in social interactions, establish meaningful connections, communicate effectively, and navigate learning and behavioral expectations that may come more naturally to neurotypical individuals.

### SUMMARY

An electronic device (such as a cellular telephone, a wearable electronic device or a computer) is described. This electronic device includes: an interface circuit that communicates with a computer system; a computation device (such as a processor and/or a graphics processing unit or GPU); and memory. During operation, the electronic device receives images, as a function of time, of a group of individuals in an environment (such as a physical environment or an environment associated with an application). Then, the electronic device dynamically determines attention or an indicia of an emotional state of individuals in the group of individuals based at least in part on nonverbal communication by the group of individuals in the images. Moreover, the electronic device dynamically aggregates a subset of the group of individuals having a particular determined attention or indicia. Next, the electronic device provides information corresponding to the subset of the group of individuals having the particular determined attention or indicia.

Moreover, the electronic device may identify a culture of at least a subset of the group of individuals, and the dynamic determined attention or emotional state may be based at least in part on the identified culture. Note that the identified culture may be different from a second culture of at least a second subset of the group of individuals, and the dynamic determined attention or emotional state may be based at least in part on the identified second culture.

Furthermore, a format of the information may be based at least in part on the dynamically determined attention or the emotional state. For example, different formats may be used to provide information corresponding to different dynamically determined attention levels or different emotional states. In some embodiments, the format may include a sensory stimulus corresponding to the information.

Additionally, the information may include sampled data and associated timestamps. The sampled data may correspond to a dynamic change (e.g., as a function of the time) in the attention or emotional state of at least the subset of the group of individuals.

In some embodiments, the electronic device may receive from a second electronic device (which may be associated with a moderator or an administrator) second information specifying boundaries of one or more aggregated subgroups (such as the aggregated subgroup). Note that the electronic device may provide, addressed to the second electronic device, suggestions for maximizing a criterion associated with the aggregated subgroup, e.g., a size, consistency, balance, etc. of the aggregated subgroup. The second information may include selections from the provided suggestions. Alternatively or additionally, the suggestions may include: a level of cross-talk among a certain number of individuals in at least a pair of aggregated subgroups (such as a side negotiation), a threshold for a number of individuals in one or more of the aggregated subgroups appearing disappointed, etc. Note that the suggestions may include suggestions for changing tone and/or content in order to achieve a user-defined criterion, e.g., in response to the dynamically determined attention or indicia. For example, the suggestions may include a remedial action to achieve a user-defined maximization criterion and/or to modify the dynamically determined attention or indicia.

Moreover, the information may include a context associated with the dynamically determined attention or emotional state.

Furthermore, the information may include directional information.

Another embodiment provides the computer system that performs counterpart operations to at least some of the aforementioned operations. During operation, the computer system may receive information corresponding to a dynamic attention or an indicia of an emotional state of at least a subset of a group of individuals in an environment (such as a physical environment or an environment associated with an application). Then, the computer system may access additional data corresponding to a second dynamically determined attention or a second indicia of an emotional state of at least a second subset of a second group of individuals. Moreover, the computer system may combine the information and the additional data. Next, the computer system may access predefined training preferences. Furthermore, the computer system may determine a predictive model based at least in part on the information and the additional data, and the predefined training preferences.

Note that the predictive model may indicate occurrences of a type of event based at least in part on an input specifying a third dynamically determined attention or indicia of an emotional state of at least a third subset of a third group of individuals.

Moreover, the determining may include training the predictive model.

Furthermore, prior to the determining of the predictive model, the computer system may filter the information to obtain a subset of the information.

Another embodiment provides a computer-readable storage medium for use with the electronic device and/or the computer system. When executed by the electronic device and/or the computer system, this computer-readable storage medium causes the electronic device and/or the computer system to perform at least some of the aforementioned operations or counterparts to at least some of the aforementioned operations.

Another embodiment provides a method, which may be performed by the electronic device and/or the computer system. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication between a computer system and one or more electronic devices in accordance with an embodiment of the present disclosure.

FIG. 2 is a block diagram illustrating an example of a computer system in accordance with an embodiment of the present disclosure.

FIG. 3A is a flow diagram illustrating an example of a method for providing information using an electronic device in FIG. 1 in accordance with an embodiment of the present disclosure.

FIG. 3B is a flow diagram illustrating an example of a method for determining when and how to engage in connecting, grouping, and sharing information between users in an environment in accordance with an embodiment of the present disclosure.

FIG. 4 is a drawing illustrating an example of communication between a computer system and an electronic device in FIG. 1 in accordance with an embodiment of the present disclosure.

FIG. 5 is a flow diagram illustrating an example of a method for determining a predictive model using a computer system in FIG. 1 in accordance with an embodiment of the present disclosure.

FIG. 6 is a drawing illustrating an example of communication among components of a computer system in FIG. 1 in accordance with an embodiment of the present disclosure.

FIG. 7 is a drawing of a user interface for a video-conferencing platform in accordance with an embodiment of the present disclosure.

FIG. 8 is a drawing of a user interface for a social-media application in accordance with an embodiment of the present disclosure.

FIG. 9 is a drawing of a user interface for a mental-health application in accordance with an embodiment of the present disclosure.

FIG. 10 is a drawing of a user interface for a user-interface associated with an electronic device in accordance with an embodiment of the present disclosure.

FIG. 11 is a block diagram illustrating an example of an electronic device in accordance with an embodiment of the present disclosure.

FIG. 12 illustrates an example machine-learning (ML) architecture that can be used to implement some aspects of the disclosed technology.

Note that like reference numerals refer to corresponding parts throughout the drawings. Moreover, multiple instances of the same part are designated by a common prefix separated from an instance number by a dash.

### DETAILED DESCRIPTION

As discussed previously, many people have difficultly interpreting non-verbal communication cues, affect, body language, etc. For example, it can be challenging for some individuals to pick up, comprehend fully, and react appropriately to non-verbal communication because of some neurodiversity, such as ASD and its associated profiles, along with each person's subjective conscious experience shaped by their background, culture, lived traumas, current focus of awareness/state of mind, etc.

Similarly, communications in virtual environments present challenges to participants in understanding the rich dynamics between people including becoming aware of and comprehending individuals' and subsets of individuals' facial cues, affect, body language, etc.

Modern psychology recognizes that human connection is a fundamental need, comparable in importance to other basic physiological needs like food, shelter, and the drive to procreate. This perspective is practically universally supported by experts. These psychological needs include friendships, intimacy, family, etc. and deep, meaningful human connections. Indeed, research shows that having a strong network of support can significantly impact physical and mental health outcomes, both short- and long-term.

Additionally, neuroscientific research has revealed that social interaction and connections activate specific areas in the brain that are crucial for emotional and social processing and that the lack of social connections is associated with increased risk of depression, anxiety, and other mental health issues.

From these perspectives, modern psychology and neuroscience show that deep, meaningful human connection is not just beneficial, but essential for emotional resilience, mental health, and overall well-being. Therefore, as used herein the terms ‘deep’, ‘dynamic’, ‘rich’, ‘meaningful’ shall refer to the complex and interwoven elements of human connections, as well as connections between members of a group of individuals, subsets of members of groups, etc.

In the present disclosure, a metaphor of a woven tapestry is used to convey the aforementioned complexity and richness of human connections. Just as a tapestry's beauty and depth come from the intricate and careful weaving of different threads, human connection described as a ‘tapestry’ suggests a multitude of subjective factors, lived stories, levels of neurotypicality/neurodiversity interwoven together, creating something complicated, detailed, and full of minor details (e.g., individual threads with individual color and texture) forming shapes (such as human interactions) that contribute to the overall picture (e.g., deep, meaningful connection). This metaphor conveys the idea that the whole (e.g., deep, meaningful human connection) is greater than the sum of its parts (e.g., an individual's background and subjective experience), and every human element, or thread, plays a role in the composition of the final picture.

Some embodiments of the present technology involve providing information to individuals related to the attention of another person, a group of people, etc. or related to certain indicia of emotional response, such that those individuals can have a more-rich view of others and deep, meaningful connections with other individuals and with groups and subgroups.

Additionally, in some embodiments, users of the technology can create individualized profiles defining their backgrounds, privacy and notification preferences, cognitive profiles, etc. Consequently, when multiple users of the technology, each with their own profile, connect using the present technology, their profiles can be processed, compared, etc. and their subjective experiences can be woven (such as digitally) together to provide information to users to allow users to experience greater complexity and richness in their relationships and connections.

Some embodiments of the present technology involve acquiring images (e.g., time-stamped video images) of people and environments. Using these images and user profiles describing users' subjective selves, the present technology performs insight discovery relating to individuals, groups, subsets of groups and environments with image processing, computer vision, deep learning, predictive machine learning models, model refinement techniques, large language models, etc. Insight discovery may include determining information about attention, indicia of emotional state, contextual information, etc.

Some embodiments of the present technology also involve making predictions about attention and emotions of observed individuals in an environment by analyzing images of individuals (e.g., real-time video) using a variety of computing techniques, such as by levering facial recognition technology and artificial intelligence or machine learning to determine more accurately, more quickly, and to greater levels of detail, how facial cues, affect, body language, etc. reflects attention and/or indicia of emotional state.

Additionally, images from user devices can also reveal context of an environment, e.g., emotional context (such as a ‘tense’ environment, a ‘joyful’ environment, a ‘collaborative’ environment), situational context of an environment (e.g., a cake, pinata, and balloons can reveal a birthday party and a long table with arranged chairs and people in business suits can reveal a business meeting), etc.

Some embodiments of the present technology also involve providing information to users in the form of learned/predicted insights related to an individual, to a group of individuals, to a subset of a group, etc. The information may include recommendations for how to react to certain people experiencing certain emotions, information related to an unfamiliar culture, information about various profiles of neurodiversity, etc., as well as recommendations for maximizing a response or other criteria (e.g., maximize ‘happy’ emotions as revealed in facial cues, maximize attentiveness of a subset of the individuals in a group, maximize the potential for interconnectedness as enabled by examining user profiles and real-time affect data, etc.) from an individual or group of individuals.

The present technology can also be used by an individual to learn, train, etc. how to identify someone's attentional state and/or how to learn about emotional response as communicated via non-verbal communication and/or emotional response behaviors of a group of individuals or subsets of individuals within a group. Also, given the ubiquity of personal electronic devices, image recording devices, high-powered processors (e.g., using GPU and artificial intelligence chips locally on consumer devices), the present technology can be implemented in a distributed manner at scale.

Some embodiments of the present technology may involve determining when to engage in grouping users in an environment. In the present disclosure, the term ‘instance’ is sometimes used to describe a group of users of the present technology, clustered by common connection to one or more networks that can access processing devices for performing the operations in one or more embodiments of the invention.

As explained in greater detail below, at least two types of common occurrences of ‘instances’, as described herein are ‘prearranged’ and ‘organic’. For example, a pre-arranged instance may include multiple users in a special education class for a group of students experiencing some form of neurodiversity. In another example, a prearranged instance may include a business meeting, either in-person or virtual. ‘Organic’ instances may be dynamically created, expanded, changed, etc. For example, when two or more users of the present technology meet a threshold connection criterion (such as proximity, same demographic, similar cognitive profile, etc.), an instance may be initiated.

In the disclosed embodiments, an electronic device (such as a cellular telephone, a wearable electronic device, a computer, an Internet-of-things device, a Global Positioning System or GPS device, a customer relationship management device, a brain-machine interface device, etc.) is described. During operation, the electronic device may receive (or access) images, as a function of time, of a group of individuals in an environment (such as a physical environment or an environment associated with an application). Then, the electronic device may dynamically determine attention or an indicia of an emotional state of individuals in the group of individuals based at least in part on nonverbal communication by the group of individuals in the images. Additionally, the electronic device can dynamically aggregate a subset of the group of individuals having a particular determined attention or indicia. Next, the electronic device may provide information corresponding to the subset of the group of individuals having the particular determined attention or indicia.

Depending on the desired implementation, the information may be presented in various formats, including visual overlays on a display screen, pop-up notifications on a computer or mobile device, graphical representations within an application interface, or audio cues through a connected audio system. In some embodiments, the electronic device may integrate with an augmented reality (AR) display system, such as AR smart glasses, to overlay visual indicators onto a user's field of view. For example, AR smart glasses may highlight individuals within a group based on their detected engagement level, display floating icons representing emotional states above their heads, or provide directional indicators to guide the user's attention toward key areas of interest within the environment.

In some embodiments, the electronic device may identify a culture of at least a subset of the group of individuals, and the dynamic determined attention or emotional state may be based at least in part on the identified culture. By providing the information, these insight discovery techniques may improve understanding and situational awareness of the impact and/or reaction of one or more individuals. For example, the insight discovery techniques may provide insight regarding the efficacy of a presentation or content, such as during a video conference. More generally, the insight discovery techniques may allow an individual to understand the rich dynamics (such as the colors, textures of the threads of a social tapestry, the shapes woven together, and the overall beauty and complexity of a woven social tapestry of human connection) during interactions between individuals, including during virtual interactions (such as during a phone call or video conferencing) and/or in-person interactions. Consequently, the insight discovery techniques may be used during one-on-one interactions, one-to-many interactions and/or interactions in a group of individuals. Therefore, the insight discovery techniques may reduce user frustration and may increase user engagement with a wide range of applications.

More generally, known attempts at providing insights related to non-verbal communication cues are lacking. First, known attempts use limited sets of data to provide insight. For example, known facial recognition solutions usually only use face data alone without taking into account any other emotional or situational context. Also, known attempts often only consider single individuals, not groups or aggregated subsets of groups. Known attempts also do not leverage a distributed network of users for providing multi-dimensional (e.g., other users' insight discovery can be communicated to, factored by, and/or used by another user) understanding within groups.

Additionally, known solutions do not adequately allow the communication of the onset, persistence, or tapering off of emotions (e.g., someone is becoming upset, a group is still confused, a subset of a group is no longer intensely attentive) to an end user.

Also, current approaches typically do not employ specific machine learning or artificial intelligence training techniques, such as training on local (e.g., local cohort data), training on group interactions and collective affect, deploying the artificial intelligence/machine-learning processing over distributed networks and/or locally on consumer electronics (e.g., moving processing load to dedicated processing space with virtual instance and/or to a dedicated artificial-intelligence chips on local devices once a local instances are created.

In some embodiments of the present technology, these and other problems are addressed using insight discovery, aggregating of sets of people within groups, and delivering insights to be used to better understand ourselves and others.

In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, Bluetooth low energy, a cellular-telephone network or data network communication protocol (such as a third generation or 3G communication protocol, a fourth generation or 4G communication protocol, e.g., Long Term Evolution or LTE (from the 3^{rd} Generation Partnership Project of Sophia Antipolis, Valbonne, France), LTE Advanced or LTE-A, a fifth generation or 5G communication protocol, a low-power wide area network (LPWAN) cellular technology (such as CAT-M1, narrow band Internet of things, etc.), or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Bluetooth and Ethernet are used as illustrative examples.

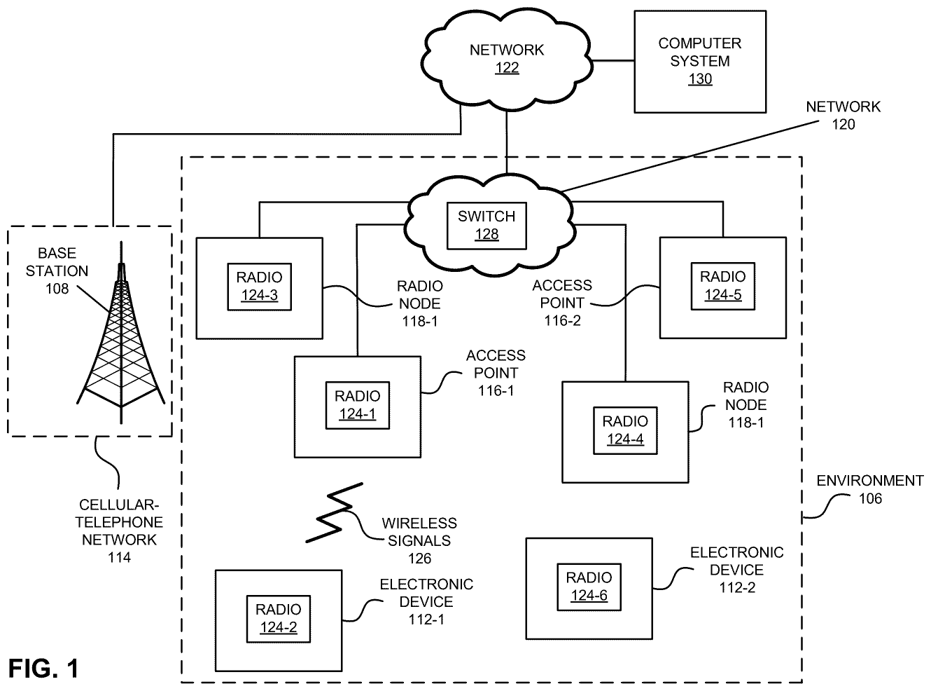

We now describe some embodiments of the insight discovery techniques. FIG. 1 presents a block diagram illustrating an example of communication between electronic devices 112 (such as a cellular telephone, a portable electronic device, or another type of electronic device, etc.). Moreover, electronic devices 112 may optionally communicate via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 112 may optionally communicate with computer system 130 (which may include one or more computers or servers, and which may be implemented locally or remotely to provide storage and/or analysis services) using a wired communication protocol (such as Ethernet) via network 120 and/or 122. Note that networks 120 and 122 may be the same or different networks. For example, networks 120 and/or 122 may be a LAN, an intra-net or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

Electronic devices 112 (such as electronic device 112-1) and/or computer system 130 may implement at least some of the operations in the insight discovery techniques. Notably, as described further below, electronic device 112-1 and/or computer system 130 may perform at least some of the analysis of images acquired or accessed by electronic device 112-1, and may provide information (and, more generally, feedback) to a user of electronic device 112-1, a user of electronic device 112-2 and/or computer 130.

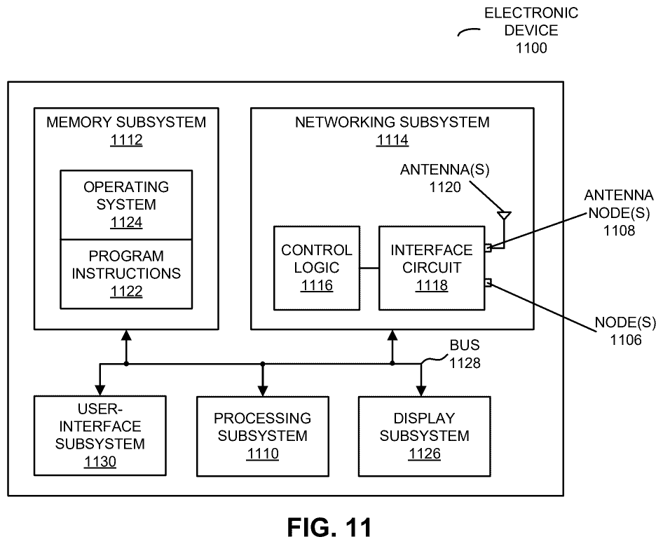

As described further below with reference to FIG. 11, base station 108, electronic devices 112, access points 116, radio node 118, switch 128 and/or computer system 130 may include subsystems, such as a networking subsystem, a memory subsystem and a processor subsystem. In addition, electronic devices 112, access points 116 and radio node 118 may include radios 124 in the networking subsystems. More generally, electronic devices 112, access points 116 and radio node 118 can include (or can be included within) any electronic devices with the networking subsystems that enable electronic devices 112, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, electronic devices 112, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic device 112-1. For example, radio 124-1 in access point 116-1 may transmit information (such as one or more packets or frames) using wireless signals 126. These wireless signals are received by radio 124-2 in electronic device 112-1. This may allow access point 116-1 to communicate information to other access points 116 and/or electronic device 112-1. Note that wireless signals 126 may convey one or more packets or frames.

In the described embodiments, processing a packet or a frame in one or more electronic devices in electronic devices 112, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) or multiple input multiple output (MIMO).

Although we describe the network environment shown in FIG. 1 as an example, in alternative embodiments, different numbers or types of electronic devices may be present. For example, some embodiments comprise more or fewer electronic devices. In some embodiments, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

As discussed previously, it can be difficult to fully, or even partially, interpret or understand the complicated and dynamic interactions between individuals, groups, subsets of groups, either in-person or virtually. These difficulties are often compounded by the multitude of subjective biological factors, backgrounds, cultures, lived stories, lived trauma, levels of neurotypicality/neurodiversity, etc.

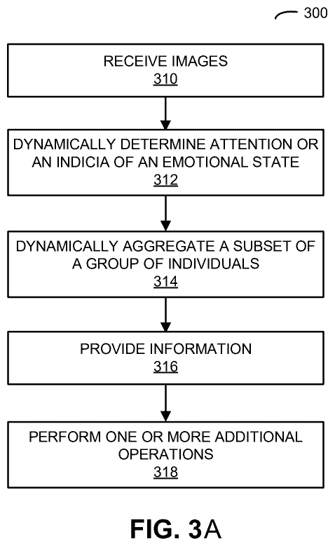

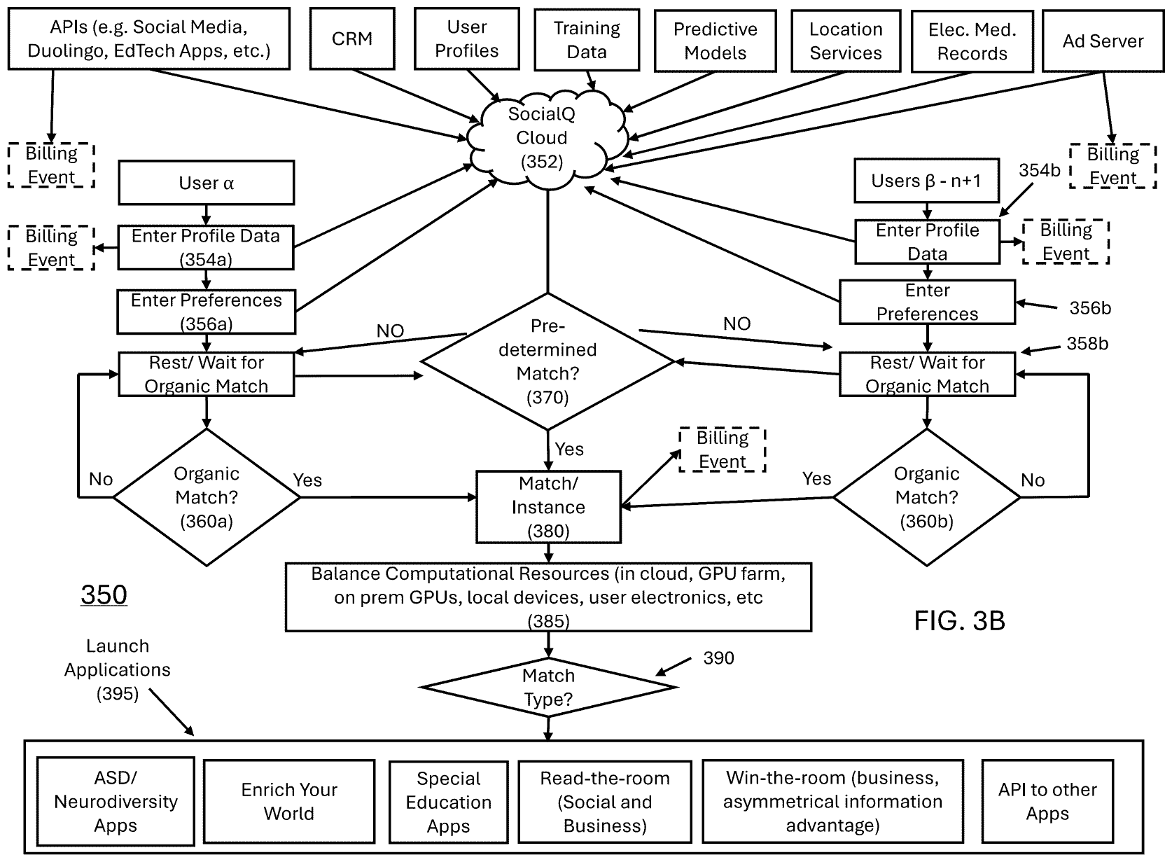

These problems can be addressed using the disclosed insight discovery techniques. With reference to FIGS. 3-10, the insight discovery techniques may be implemented by electronic device 112-1 (such as a cellular telephone, a wearable electronic device or a computer) while a user of electronic device 112-1 interacts with one or more other individuals. For example, the user may use an application on electronic device 112-1 that implements the insight discovery techniques while physically or directly interacting (such as during a conversation) with one or more other individuals. The insight discovery techniques can also be used by a single user, classroom of users, etc. to learn insights in an educational/training session.

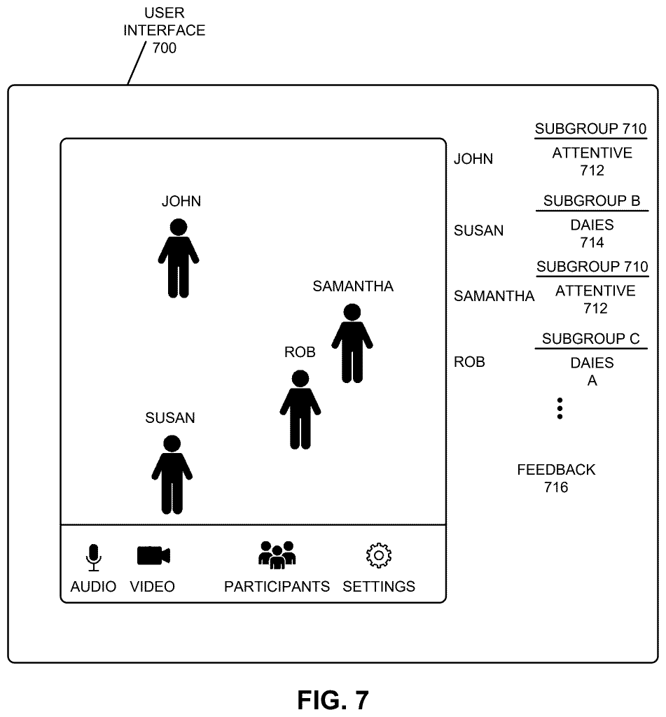

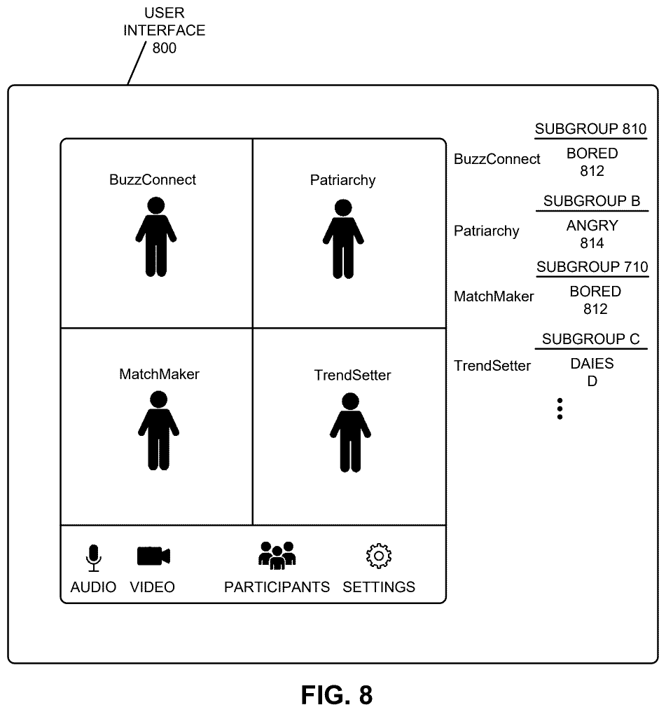

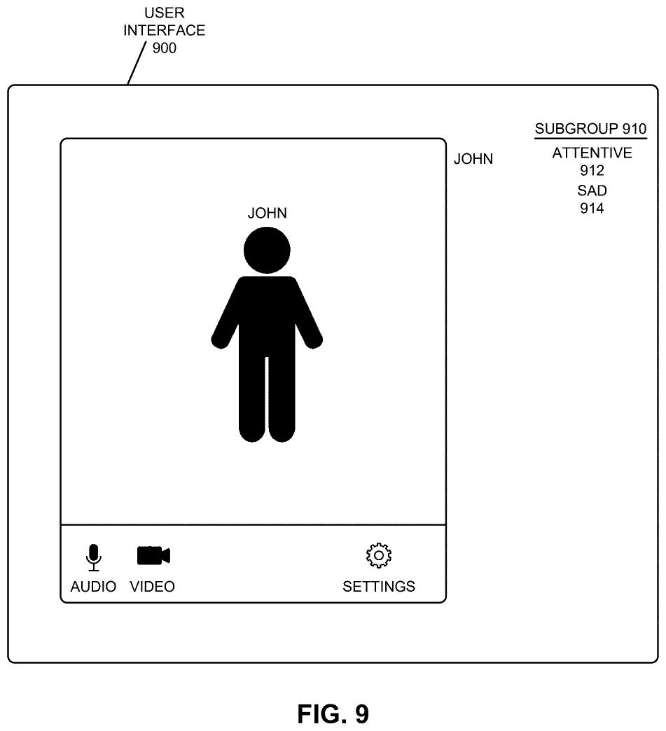

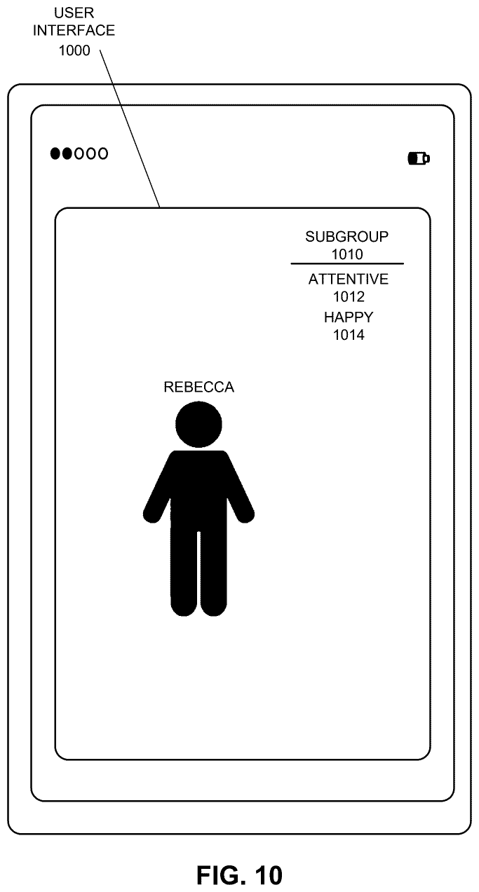

Additionally, the present technology can also be implemented in a distributed manner between groups of users. For example, the user may use an application on electronic device 112-1 that implements the insight discovery techniques while interacting virtually with one or more other individuals. Notably, the insight discovery techniques may be used while the user: uses a social-media application (as shown in FIG. 7); uses a social-media application (as shown in FIG. 8); interacts with a mental-health professional (as shown in FIG. 9); and/or physically or virtually interacts with one or more other individuals (as shown in FIG. 10). During the insight discovery techniques, electronic device 112-1 may receive one or more images, as a function of time, of a group of individuals in an environment (such as a physical environment or an environment associated with an application). Based at least in part on the images, electronic device 112-1 may dynamically determine attention or an indicia of an emotional state of one or more individuals in the group of individuals based at least in part on nonverbal communication by an individual, a subset of individuals in the group, or the entire group of individuals in the one or more images. In some embodiments, electronic device 112-1, computer system 130, and/or more than one of electronic devices 112 working together, etc. may use a pretrained model to analyze images and determine, from the images, information about attention or an indicia of an emotional state of one or more individuals in the group. Moreover, in some embodiments, the pretrained model may dynamically determine the attention or the indicia of an emotional state based at least in part on the nonverbal communication. Furthermore, the model may be pretrained model to recognize emotional state based on facial expressions. Additionally, electronic device 112-1 uses a pretrained model, which was received from computer system 130. Note that methods of training one or more predictive and/or generative models, as well as inputs to the models and outputs from the models, are described in more detail below.

In addition to determining attention or an indicia of an emotional state of one or more individuals, electronic device 112-1, computer system 130, and/or more than one of electronic devices 112 working together, etc. can determine various kinds of situationally contextual information from the one or more images. For example, the systems can use computer vision and determine, from the images, certain objects, ddcor, positioning of people, time of day, location, etc. that are indicative of certain activities (e.g., a cake, a pinata and balloons are indicative of a birthday party, while a long table, arranged chairs and people in business suits is indicative of a business meeting). Similarly, electronic device 112-1, computer system 130, and/or more than one electronic device 112 working together, etc. can determine emotionally contextual information from the one or more images.

In some cases, electronic device 112-1, computer system 130, and/or more than one of electronic devices 112 working together, etc. can communicate with a variety of other electronic devices and web-based services to provide a more complete and accurate profile for determining situational (as well as emotional) contextual information. For example, electronic device 112-1, computer system 130, and/or more than one of electronic devices 112 working together, etc. can communicate with: a GPS service, environmental sensing and Internet of Things (IoT) devices, a customer relationship management (CRM) tool, and/or a wearable device equipped with GPS and motion sensors that can detect activities such as walking, running, cycling, and potentially driving. Additionally, a machine-learning model can be trained using some or all of these and more sensing modalities to accurately predict situational context.

In some cases, electronic device 112-1 may dynamically aggregate a subset of the group of individuals having a particular determined attention or indicia. Aggregating a subset of individuals having some level of attention or some shared emotional response can provide unique insights in group dynamics and also how individuals behave within groups and subsets of groups. For example, in a virtual business meeting, it can be useful to identify the subset of people that have authority to make a decision or the technical expertise to implement a solution. In another example, in a social situation (e.g., a child's birthday party), it can be useful to identify groups of participants that have an ‘open’ posture indicating their willingness to engage with someone new and participants that have already been grouped off with a ‘closed’ posture.

Note that electronic device 112-1 may provide insight information corresponding to the subset of the group of individuals having the particular determined-attention or indicia to a user. This insight information can include a wide variety of indications (e.g., about an individual's, a group's, or a subset of a group's emotional state) recommendations (e.g., how to respond to someone in a particular emotional state), predictions (e.g., predictions related to what contextual information caused what emotional response), priming signals (e.g., intended to elicit a particular emotional response from the user), etc.

Moreover, the insight information may include contextual information related to the determined situational and/or emotional context. For example, the situational context may include a type of the environment (such as a physical environment, a virtual meeting, augmented reality, etc.), a determined event (such as a birthday party, a business meeting, a funeral, etc.) and the emotional context can include the mood of an environment, the collective state of mind of a group, a change in mood as a function of time, a severity of an emotional response, etc.).

Furthermore, electronic device 112-1 can process the insight information, repackage the insight information, display the insight information, train predictive models using the insight information, etc. Also, electronic device 112-1 can deliver the insight information to one or more other electronic devices. The insight information can be delivered to end users in a wide variety of ways described herein or that will be apparent to those having ordinary skill in the art.

As explained above, some embodiments of the insight discovery techniques may involve dynamically aggregating a subset of the group of individuals having a particular determined attention or indicia. In some embodiments, electronic device 112-1 may identify a culture of at least a subset of the group of individuals, and the dynamic determined attention or emotional state may be based at least in part on the identified culture. Note that the identified culture may be different from a second culture of at least a second subset of the group of individuals, and the dynamic determined attention or emotional state may be based at least in part on the identified second culture.

Moreover as explained above, electronic device 112-1 may provide information corresponding to the subset of the group of individuals having the particular determined-attention or indicia. Moreover, a format of the information may be based at least in part on the dynamically determined attention or the emotional state. For example, different formats may be used to provide information corresponding to different dynamically determined attention levels or different emotional states. In some embodiments, the format may include a sensory stimulus (such as text, haptic feedback or a buzzing noise) corresponding to the information.

Furthermore, the information may include sampled data and associated timestamps. The sampled data may correspond to a dynamic change (e.g., as a function of the time) in the attention or emotional state of at least the subset of the group of individuals.

In some embodiments, electronic device 112-1 may receive, from a second electronic device, such as electronic device 112-2 (which may be associated with a moderator or an administrator) second information specifying boundaries of one or more aggregated subgroups (such as the aggregated subgroup). Note that electronic device 112-1 may provide, addressed to electronic device 112-2, suggestions for maximizing a criterion associated with the aggregated subgroup, e.g., a size, consistency, balance, etc. of the aggregated subgroup. The second information may include selections from the provided suggestions. Alternatively or additionally, the suggestions may include: a level of cross-talk among a certain number of individuals in at least a pair of aggregated subgroups (such as a side negotiation during a meeting), a threshold for a number of individuals in one or more of the aggregated subgroups appearing disappointed, etc. The suggestions, weights and/or thresholds in the insight discovery techniques may dependent or be based at least in part on a context, such as a type of meeting. Thus, different criteria may be applied in the insight discovery techniques for sexual harassment training (where attention and emotional awareness may be required) than for another type of meeting. Note that the suggestions may include suggestions for changing tone and/or content in order to achieve a user-defined criterion, e.g., in response to the dynamically determined attention or indicia. For example, the suggestions may include a remedial action to achieve a user-defined maximization criterion and/or to modify the dynamically determined attention or indicia. Alternatively or additionally, when the attention of at least a participant in a virtual meeting wanes, the remedial action may include random feedback to wake up the participant.

In some embodiments, computer system 130 may perform counterpart operations to at least some of the aforementioned operations of electronic device 112-1. Notably, computer system 130 may receive information corresponding to a dynamic attention or an indicia of an emotional state of at least a subset of a group of individuals in an environment (such as a physical environment or an environment associated with an application). Then, computer system 130 may access additional data (such as historical data) corresponding to a second dynamically determined attention or a second indicia of an emotional state of at least a second subset of a second group of individuals. The additional data may include interactions that occurred after a previous instance of a predictive model was trained and/or may include the results of a subsequent study after the previous instance of the predictive model was trained. Moreover, computer system 130 may combine the information and the additional data. For example, the information and the additional data may correspond to or have a common culture, which may indicate that the information and the additional data can be aggregated into a training dataset by computer system 130. Next, computer system 130 may access predefined training preferences (such as hyperparameters for a neural network). Furthermore, computer system 130 may determine a predictive model based at least in part on the information and the additional data, and the predefined training preferences. Additionally, computer system 130 may provide the pretrained predictive model (or information specifying the pretrained predictive model) to electronic device 112-1.

Note that the predictive model may indicate occurrences of a type of event based at least in part on an input specifying a third dynamically determined attention or indicia of an emotional state of at least a third subset of a third group of individuals.

Moreover, the determining may include training the predictive model.

Furthermore, prior to the determining of the predictive model, computer system 130 may filter the information to obtain a subset of the information.

In these ways, the insight discovery techniques may facilitate improved understanding and situational awareness of the impact and/or reaction of one or more individuals. More generally, the insight discovery techniques may allow an individual to understand the rich dynamics during interactions between individuals, including during virtual interactions (such as during a phone call or video conferencing) and/or in-person interactions.

In some examples, the insight discovery techniques may be used by an individual having impaired social understanding, which may extrinsic (such as during a virtual meeting) and/or intrinsic (such as an individual that has ASD, Asperger's Syndrome, a learning disability, or an individual having communication challenges, such as stroke survivor, or an individual having another medical or mental-health condition). Therefore, the insight discovery techniques may reduce user frustration and may increase user engagement with a wide range of applications.

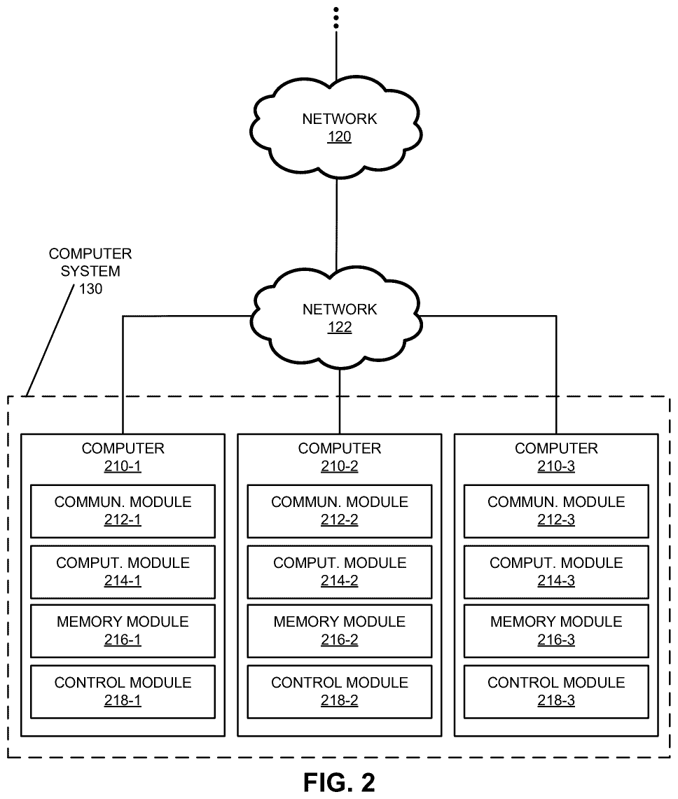

FIG. 2 presents a block diagram illustrating an example of a computer system 130. This computer system may include one or more computers 210. These computers may include communication modules 212, computation modules 214, memory modules 216, and optional control modules 218. Note that a given module or engine may be implemented in hardware and/or in software.

Communication modules 212 may communicate frames or packets with data or information (such as measurement results or control instructions) between computers 210 via a network 122 (such as the Internet and/or an intranet). For example, this communication may use a wired communication protocol, such as an IEEE 802.3 standard and/or another type of wired interface. Alternatively or additionally, communication modules 212 may communicate the data or the information using a wireless communication protocol, such as: an IEEE 802.11 standard, Bluetooth, a third generation or 3G communication protocol, a fourth generation or 4G communication protocol, e.g., Long Term Evolution or LTE, LTE Advanced (LTE-A), a fifth generation or 5G communication protocol, other present or future developed advanced cellular communication protocol, or another type of wireless interface.

In the described embodiments, processing a packet or a frame in a given one of computers 210 (such as computer 210-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 2 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 2 uses one or more bands of frequencies, such as: 900 MHz, 2.4 GHz, 5 GHz, 6 GHz, 60 GHz, the CBRS (e.g., a frequency band near 3.5 GHz), and/or a band of frequencies used by LTE or another cellular-telephone communication protocol or a data communication protocol. In some embodiments, the communication between the components may use multi-user transmission (such as OFDMA).

Moreover, computation modules 214 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 216 may access stored data or information in memory that local in computer system 130 and/or that is remotely located from computer system 130. Notably, in some embodiments, one or more of memory modules 216 may access stored measurements (such as one or more images) in local memory.

Alternatively or additionally, in other embodiments, one or more memory modules 216 may access, via one or more of communication modules 212, stored measurements in a remote memory, e.g., via network 120 and network 122. Thus, in some embodiments at least some of the images (and, more generally, measurements) may have been received previously and may be stored in memory, while in other embodiments at least some of the measurement results may be received in real-time from, e.g., electronic device 112-1.

During the insight discovery techniques, one or more of communication modules 212 may receive information corresponding to a dynamic attention or an indicia of an emotional state of at least a subset of a group of individuals in an environment. Then, one or more optional control modules 218 may assign at least a portion of training a predictive model to one or more of computation modules 214.

Moreover, a given computation module (such as computation module 214-1) may access, via one or more of memory modules 216, additional data corresponding to a second dynamically determined attention or a second indicia of an emotional state of at least a second subset of a second group of individuals. Then, computation module 214-1 may combine the information and the additional data, such as based at least in part on a common culture of the subset and the second subset. More generally, computation module 214-1 may identify a situational context, an emotional context, regional differences, etc., and may use the user's identified profile (separately or in addition to culture) to combine the subset and the second subset. Next, computation module 214-1 may access, via one or more of memory modules 216, predefined training preferences (such as hyperparameters for a neural network).

Furthermore, computation module 214-1 may determine a predictive model based at least in part on the predefined training preferences and the information and/or the additional data. For example, computation module 214-1 may train the predictive model using the information, the additional data, and the predefined training preferences. In some embodiments, the one or more optional control modules 218 may combine training results from two or more computation modules 214 to determine the predictive model.

Additionally, one or more of communication modules 212 may provide the pretrained predictive model (or information specifying the pretrained predictive model) to electronic device 112-1.

Although we describe the computation environment shown in FIG. 2 as an example, in alternative embodiments, different numbers or types of components may be present in computer system 130. For example, some embodiments may include more or fewer components, a different component, and/or components may be combined into a single component, and/or a single component may be divided into two or more components.

FIG. 3A presents a flow diagram illustrating an example of a method 300 for providing information, which may be performed by an electronic device (such as electronic device 112-1 in FIG. 1). During operation, the electronic device may receive images (operation 310), as a function of time, of a group of individuals in an environment (such as a physical environment or an environment associated with an application). Then, the electronic device may dynamically determine attention or an indicia of an emotional state of individuals (operation 312) in the group of individuals based at least in part on nonverbal communication by the group of individuals in the images. For example, information specifying the nonverbal communication in the images may be input to a pretrained predictive model (such as a neural network), and the pretrained predictive model may output the dynamically determined attention or the indicia of the emotional state of the individuals. Methods of training one or more predictive and/or generative models, as well as inputs to the models and outputs from the models are described in more detail below.

Note that ‘nonverbal communication’ may include transmission of messages or signals via nonverbal cues, such as eye contact (oculesics), body language or posture (kinesics), social distance (proxemics), touch (haptics), voice (paralanguage), physical environments/appearance, and/or use of objects. In the context of the insight discovery techniques, ‘nonverbal communication’ may include: eye contact (including whether an individual's eyes are open, closed, blinking pattern, a blinking frequency, etc.), a gaze direction, body posture or body language, fidgeting, breathing rate, a breathing pattern, coughing, skin flushing, gestures, a facial expression, a micro-expression, vocalics (such as tempo, volume, pauses, paucity, use of filler words or vocal disfluencies such as um and er, pitch, nonverbal sounds, etc.), and/or another type of nonverbal communication. For example, inattention may be indicated by yawning, repeatedly checking a watch, or looking confused. The nonverbal communication may communicate emotion and/or attitude without using specific words. For example, vocalics may include emblems, such as sounds with clear meaning (such as saying ‘burr’ when you are cold or ‘hmm’ when you are thinking about something). In general, the nonverbal communication may be culturally dependent, age dependent, may be dependent on neurological profile, etc.

Additionally, the electronic device may dynamically aggregate a subset of the group of individuals (operation 314) having a particular determined attention or indicia. For example, the electronic device may use an unsupervised-learning technique (such as clustering) to dynamically aggregate the subset.

Next, the electronic device may provide information (operation 316) corresponding to the subset of the group of individuals having the particular determined attention or indicia. For example, the electronic device may display the information in a user interface, may acoustically output the information, etc. Note that numerous types, formats, sense modalities, etc. of the information corresponding to the determined attention and/or indicia are described explicitly in the preceding and subsequent examples and other types, formats, sense modalities, etc. of the information corresponding to the determined attention and/or indicia will be apparent to those having ordinary skill in the art with the benefit of this disclosure.

As briefly mentioned above, in some embodiments, the information corresponding to the determined attention and/or indicia can be used to deliver a signal intended to elicit a ‘priming’ response from the recipient. The concept of ‘priming’ in economics and psychology refers to the act of subtly influencing someone's behavior or thoughts by providing cues or stimuli that affect subsequent actions or reactions, without the individual being consciously aware of the influence. When considering individuals with autism, who may not typically show emotions in ways that neurotypical individuals do, priming can be tailored to their unique sensory sensitivities and communication styles including visual cues, environmental adjustments (e.g., automatically dimming the lights), sensory priming (e.g., turning up the heat can prime an individual for a more relaxed and positive emotional engagement), music and rhythm (e.g., changing a song to facilitate certain emotions), and positive affirmations (e.g., general audible feedback, specific (individualized) audible feedback, points, tokens, gamification, etc.

Individuals with autism often respond well to visual stimuli like pictures, symbols, or videos that depict a specific emotional response or action. Presenting this type of stimuli (e.g., in a pair of smart glasses) before a social interaction can help prime a user with a neurodivergent cognition profile for that interaction. For example, showing a video of people sharing toys before playtime can prime an individual with autism for sharing behavior. In some embodiments, these cues can be displayed on monitor, smart watch, smart glasses, using augmented reality, etc.

In some embodiments, the providing of information (operation 316) may involve providing a confidence factor to the information. First, during the determining (operation 312) in method 300 may involve determining (e.g., using a predictive model) a confidence factor related to the determined attention or indicia of emotion. For example, it may be difficult to disambiguate a smile of joy from a smile of mischief. Accordingly, a predictive model can assign a confidence factor to a prediction and the information can include the confidence factor as part of the information (e.g., “this person might be angry”).

Also, in some embodiments, the providing of information (operation 316) may involve providing temporal information about the information. During the determining (operation 312) in method 300 may involve determining (e.g., using sampled data corresponding to a dynamic change and timestamps, normalizing time, using a predictive model, etc.) a temporal tendency related to the determined attention or indicia of emotion. For example, the information may describe the onset, persistence, tapering off of emotions (such as someone is becoming upset, a group is still confused, a subset of a group is no longer intensely attentive, etc.) to an end user. Combining a temporal nature with a confidence score for an aggregation of a subset of individuals can provide synergistically powerful information, e.g., “it looks like this subset of a group of individuals are simultaneously becoming interested”).

In some embodiments, the providing of information (operation 316) may involve providing information in one or more format, e.g., hyperpersonalized for a user based at least in part on their age, educational level, preferences, privacy settings, cognitive ability, context, etc. For example, the format may take the form of easily recognizable emoticons (aka emojis) for young users, those users not comfortable with a native written language, or those users not familiar with the complexities of nuanced emotions (such as the difference between ‘bittersweet’ and ‘sad’), etc. In some examples, emoticons can also represent temporally dynamic information (e.g., the sentiment that a person is becoming sad can be represented as “ [symbol] -> [symbol] -> [symbol] ”). In some embodiments, the information can be formatted as textual information in the form of a notification, overlay, popup, etc. that can be displayed on the display of a computer, smartphone, smartwatch, smart glasses, augmented reality platform, etc. Additionally, the format of the information may include audio information, suggestions, translations, etc. Moreover, in some embodiment, the information may be provided in the form of tactile feedback. For example, a thermal pad or a haptic pad may be applied to a user's clothing, skin, etc. and may vibrate to provide information in the form of cold, heat and/or vibrations.

In some embodiments, a format of the information may be based at least in part on the dynamically determined attention or the emotional state (operation 312). For example, different formats may be used to provide information corresponding to different dynamically determined attention levels or different emotional states. In some embodiments, the format may include a sensory stimulus corresponding to the information. These capabilities may allow the insight discovery techniques to be used to provide an intuitive ‘feeling’ for the dynamically determined attention level or emotional state without taxing the user's conscious thinking. For example, a determined feeling of ‘love’ may be provided by an electronic heating patch applied to the chest. In another example, a vibration of a haptic patch on the back of a user's neck (e.g., shirt tag) can communicate ‘surprise’ and may even cause a fight or flight response (e.g., hair standing on back of neck) associated with surprised fear. Similarly, a haptic vibration of the abdomen may replicate the feeling of ‘butterflies in the stomach’ when a ‘nervous’ emotion is provided.

Note that in some embodiments, the format may be associated with the ways a human naturally responds to a type of emotion. This may facilitate non-intuitive or non-conscious processing of information, and thus may result in faster processing or a faster reaction by the user. For example, an emotional state of surprise may be conveyed using a piezoelectric vibration (so that the information or feedback can be felt). Alternatively, an emotional state of sadness may be conveyed by displaying a sad emoji or a sad facial expression (so that the information or feedback is cognitive and involves processing by the prefrontal cortex). In some embodiments, the information corresponding to the determined attention and/or indicia may be input into a brain-machine interface for accessing a human's nervous system.

In some embodiments, providing the information may include selectively and dynamically providing additional images.

Additionally, the information may include directional information. For example, the information may be delivered with environmental context. Thus, a person who is sad on the far right end of a room may cause a frown emoji to be displayed on the top right of a user interface in a display or smart glasses, while person who is happy in near left of the room can cause smile emoji to be displayed on the bottom left of the display or the glasses. Furthermore, a person behind you with an angry face could cause a haptic pulse on the back of your neck (which is sometimes referred to as ‘spidey-sense’).

In some embodiments, the electronic device optionally performs one or more additional operations (operation 318). For example, the electronic device may identify a culture of at least a subset of the group of individuals, and the dynamic determined attention or emotional state (operation 312) may be based at least in part on the identified culture. For example, the culture may be identified using another pretrained predictive model (such as another neural network), which may be different from the pretrained predictive model that may dynamically determine the attention or the indicia of the emotional state (operation 312). Note that the identified culture may be different from a second culture of at least a second subset of the group of individuals, and the dynamic determined attention or emotional state (operation 312) may be based at least in part on the identified second culture. Thus, the dynamic determined attention or emotional state (operation 312) may be based at least in part on the subgroup to which an individual is a member and/or may be based at least in part on the subgroup to which the individual is not a member.

Moreover, the electronic device may receive from a second electronic device (which may be associated with a moderator or an administrator) second information specifying boundaries of one or more aggregated subgroups (such as the aggregated subgroup). Note that the electronic device may provide, addressed to the second electronic device, suggestions for maximizing a criterion associated with the aggregated subgroup, e.g., a size, consistency, balance, etc. of the aggregated subgroup. The second information may include selections from the provided suggestions. Alternatively or additionally, the suggestions may include: a level of cross-talk among a certain number of individuals in at least a pair of aggregated subgroups (such as a side negotiation), a threshold for a number of individuals in one or more of the aggregated subgroups appearing disappointed, etc. Note that the suggestions may include suggestions for changing tone and/or content in order to achieve a user-defined criterion, e.g., in response to the dynamically determined attention or indicia. For example, the suggestions may include a remedial action to achieve a user-defined maximization criterion and/or to modify the dynamically determined attention or indicia.

In some embodiments of the disclosed insight discovery techniques, the operations of the method 300 are performed once, periodically, regularly, iteratively, consistently, etc.

FIG. 3B describes a method 350 for determining when and how engage in connecting, grouping, and sharing information between users in an environment. Method 350 may operate in a network ecosystem with a cloud 352 (such as a SocialQ cloud) containing processing resources, memory containing instructions to execute the methods described herein, databases containing user information, predictive models, training data, etc. Cloud 352 may also interface with a number of other Web resources, data repositories, web services, etc.

FIG. 3B illustrates user α creating a profile 354A, which may include demographic information, neurodiversity profile, student profile, business profile, etc. User α may also enter preferences 356A, such as privacy preferences, notification preferences, organic match thresholding preferences, etc.

Next, method 350 involves an application on user α's electronic device waiting for an ‘organic’ match 358A and/or a predetermined match 370 with one or more other users. For example, an organic match may occur when the disclosed insight discovery techniques detect an event meeting a threshold connection criterion (e.g., user proximity, users sharing defined similar demographics, users sharing defined similar cognitive profiles, etc.).

When an organic match is detected 360A or a predetermined match is discovered or created 370, an instance 380 is created. In some examples, instance 380 is a dedicated digital space (run in the cloud, on user devices, combinations thereof, etc.) where users of the disclosed insight discovery techniques may transmit and receive insight discovery information and DAIES information, recommendations, predictions, etc.

Method 350 may also involve users β−n+1 (indicating an open set) creating profiles 354B, entering preferences 356A and an application on User β−n+1's electronic device waiting for an ‘organic’ match 358B and/or a predetermined match 370.

When a match is made and an instance 380 is created, method 350 may involve balancing computational resources 385 in the digital ecosystem to optimize fast and efficient processing of image data received by the users (locally on user electronic devices, in the cloud, on dedicated off-prem GPU servers, on local, on-prem GPU servers, etc.), determination of DAIES (e.g., based at least in part by non-verbal communication cues), determining a context of the environment, aggregating subsets of individuals in the environment, and delivering information to users, etc.

Next, depending on the match type 390, method 350 may launch one or more applications 395 for connecting users in the ecosystem for the benefit of receiving the insights described herein as well insight discovery information and DAIES information, recommendations, predictions, etc. For example, applications 395 may include applications specific to Autism Spectrum Disorder and/or other neurodiversity. Some applications 395 may be used to receive the insights and insight information from the system and be enriched, learn, discover, etc. about affect and other non-verbal information expressed by others. Some applications 395 are used in the context of special education. Some applications 395 may be used in social, business, and other contexts to discover insights in a (e.g. contextually specific) environment, e.g., read the room. Some applications 395 in a business context provide users access to an asymmetrical information advantage by receiving insights related to others' unspoken communication cues (see, e.g., sales example below), such as win the room. Also, applications 395 may include collaborations with other SocialQ or third-party software, e.g., through APIs.

As shown in method 350, various monetization options can be leveraged using the disclosed insight discovery techniques. Additionally, the disclosure insight discovery techniques may involve storing user data, insight information, historical match/instance logs, etc. This stored data represents a unique source of training data for the present insight discovery techniques, as well as for other predictive models. Taking for granted that users can define explicit privacy permissions, that the operator of the ecosystem would comply with all relevant privacy and data protection laws and regulations, the stored data may be licensed for the purpose of training one or more other predictive models.

Certain engaged connections are ‘prearranged’ and/or ‘organic.’ For example, a pre-arranged instance may include multiple users in a special education class for a group of students experiencing some form of neurodiversity. In other embodiments, a prearranged instance may include a business meeting, either in-person or virtual. ‘Organic’ instances may be dynamically created, expanded, changed, etc. For example, when two or more users of the disclosed insight discovery techniques meet a threshold connection criterion (e.g., proximity, same demographic, a similar user-defined cognitive profile, etc.), an instance can be initiated. In some embodiments, The user-defined profile may include a cognitive profile related to non-verbal communication. Note that a user profile may include user information, background, a neurological profile, sharing preferences, etc. A user-defined profile may be uploaded to a cloud-based computer system, processed using one or more predictive models in order to discover insight(s), which are then communicated to one or more electronic devices of users.

When the method 350 determines that individuals are to be grouped in engagement, the method may involve creating an instance. An instance may describe a group of users of the disclosed insight discovery techniques, clustered by common connection to one or more networks that can access processing devices for performing the operations of the disclosed insight discovery techniques.

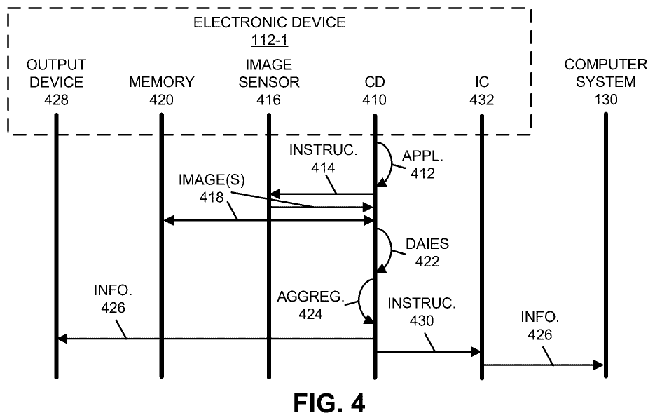

Embodiments of the insight discovery techniques are further illustrated in FIG. 4, which presents a drawing illustrating an example of communication among components in electronic device 112-1 and computer system 130. In FIG. 4, a computation device (CD) 410 (such as a processor and/or a GPU) in electronic device 112-1 may execute an application 412. This application may instruct 414 an image sensor 416 (such as a CMOS image sensor or a CCD sensor) in electronic device 112-1 to acquire one or more images 418, as a function of time, of a group of individuals in an environment (such as a physical environment or an environment associated with an application). Otherwise or additionally, the one or more images 418 may be accessed in memory 420 in electronic device 112-1.

Then, application 412 may analyze the one or more images 418 to determine a dynamic attention or an indicia of an emotional state (DAIES) 422 of at least a subset of a group of individuals in the environment based at least in part on nonverbal communication by the group of individuals in the one or more images 418. For example, information specifying the nonverbal communication in the one or more images 418 may be input to a pretrained predictive model (such as a pretrained neural network, which may be received from computer system 130 in FIG. 1), and the pretrained predictive model may output the dynamically determined attention or the indicia of the emotional state 422 of the individuals. In some embodiments, application 412 may optionally dynamically aggregate 424 a subset of the group of individuals having a particular determined attention or indicia 422.

Next, application 412 may provide information 426 corresponding to the dynamically determined attention or the indicia of the emotional state 422 and/or the subset of the group of individuals having the particular determined attention or indicia 422. For example, as described further below with reference to FIGS. 7-10, application 412 may provide information 426 to an output device 428 (such as a display) in or associated with electronic device 112-1 to display information 426 in a user interface on the display and/or may provide information 426 (such as electrical signals) to output device 428 (such as a speaker) to acoustically output the information. In some embodiments, different formats may be used to provide information corresponding to different dynamically determined attention levels or different emotional states. Alternatively or additionally, application 412 may instruct 430 an interface circuit (IC) 432 in electronic device 112-1 to provide information 426 to computer system 130.

Note that electronic device 112-1 may obtain contextual information from the images and/or from other network sources, such as: user-defined profiles, location data, a data structure with customer-relationship-management information, etc.

In some embodiments, a user of electronic device 112-1, an administrator of application 412 and/or a moderator of application 412 may specify when information 426 about the dynamically determined attention or the indicia of the emotional state 422 or the feedback is received, such as a frequency of the feedback or a time interval between instances of the feedback.

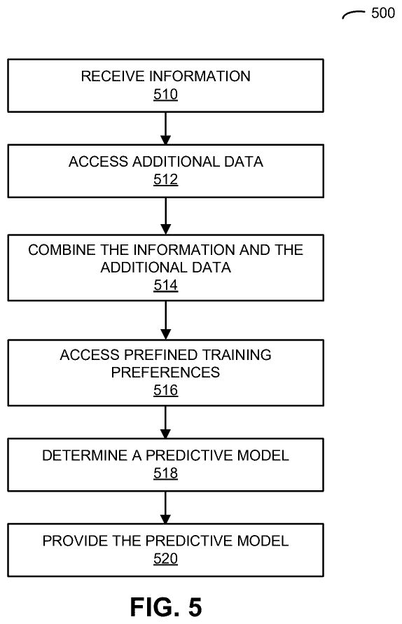

FIG. 5 presents a flow diagram illustrating an example of a method 500 for determining a predictive model, which may be performed by a computer system (such as computer system 130 in FIG. 1 or another or different computer system or electronic device, such as a distributed computer system or a local electronic device). During operation, the computer system receives information (operation 510) corresponding to a dynamic attention or an indicia of an emotional state of at least a subset of a group of individuals in an environment (such as a physical environment or an environment associated with an application). Then, the computer system accesses (e.g., in memory) additional data (operation 512) corresponding to a second dynamically determined attention or a second indicia of an emotional state of at least a second subset of a second group of individuals. For example, the additional data may include historical data. Moreover, the computer system combines the information and the additional data (operation 514). Next, the computer system accesses (e.g., in memory) predefined training preferences (operation 516). Furthermore, the computer system determines a predictive model (operation 518) based at least in part on the information and the additional data, and the predefined training preferences. For example, the predictive model may predict or output the dynamic attention or the indicia of the emotional state based at least in part on an input of second information specifying nonverbal communication by one or more individuals, such as in nonverbal communication indicated or specified by visual information in one or more images. Additionally, the computer system provides the predictive model (operation 520). Notably, providing the predictive model (operation 520) may include providing the predictive model (or second information specifying the predictive model) to an electronic device and/or storing the predictive model (or the second information specifying the predictive model) in memory.

Note that the predictive model may indicate occurrences of a type of event based at least in part on an input specifying a third dynamically determined attention or indicia of an emotional state of at least a third subset of a third group of individuals.

Moreover, the determining (operation 518) may include training the predictive model. For example, the predictive model may include a supervised-learning model, such as: random forests, a support vector machine technique, a classification and regression tree technique, logistic regression, LASSO, linear regression, a neural network technique (such as deep learning, a convolutional neural network technique, an autoencoder neural network or another type of neural network technique), a boosting technique, a bagging technique, another ensemble learning technique and/or another linear or nonlinear supervised-learning technique.

Furthermore, prior to the determining of the predictive model (operation 518), the computer system may filter the information to obtain a subset of the information.

The operations of determining a predictive model and/or training a predictive model may include additional training operations, such a training global data along with local cohort data. For example, in a local setting (e.g., such as a class room where a class photo or video yearbook is available) or a virtual setting (e.g., such as a virtual business meeting where photographs of employees and/or attendees are available in e-cards), a facial recognition model trained on global data may be refined using the local and/or virtually-local cohort data (such as the class photographs and employee headshots).

In some embodiments, predictive models may be trained to detect the onset, persistence, or tapering off of emotions.

In some embodiments of the disclosed insight discovery techniques, the historical data includes group interactions where collective group affect or the collective affect of a subset of the group is demonstrated. For example, suppose a predictive model includes training data in the form of a produced film, director's notes, and actors' commentary. The produced film portrays group interactions (where affect is more demonstrable and, therefore, may be more useful for training) where the context of human interaction is known from the plot and the group affect is demonstrated in the physical acting, from the director's line notes for actors to specify intended emotions, and from the actors' commentary about specific lines spoken between characters and the emotions they were drawing upon and attempting to convey. Collective affect may also be quantified by individually collecting data from group participants about their experiences during interactions, e.g., via bio-telemetry, survey data, attention data, etc.

In some embodiments of the disclosed insight discovery techniques, a pretrained predictive model may be updated or retrained using reinforcement learning based at least in part on human feedback, a reward model, iteration and refinement over time, etc.

In some embodiments of methods 300 (FIG. 3A), 350 (FIG. 3B) and/or 500, there may be additional or fewer operations. Furthermore, the order of the operations may be changed, and/or two or more operations may be combined into a single operation.

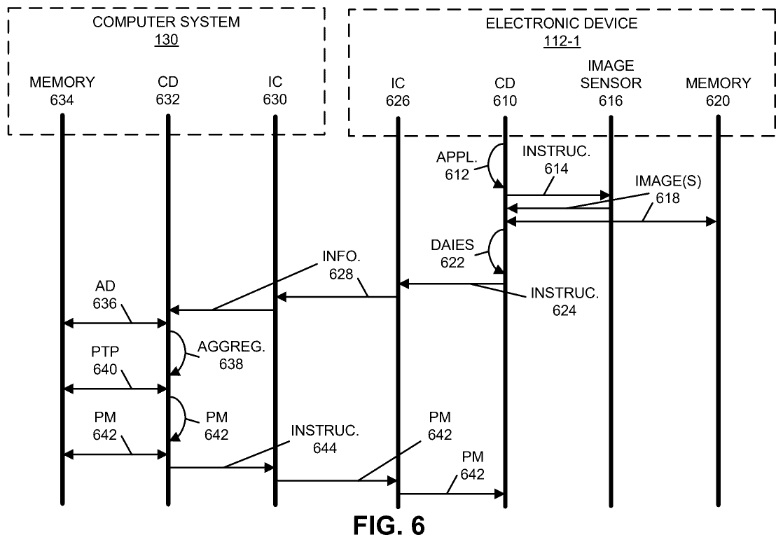

Embodiments of the insight discovery techniques are further illustrated in FIG. 6, which presents a drawing illustrating an example of communication among electronic device 112-1 and computer system 130. In FIG. 6, a computation device (CD) 610 (such as a processor and/or a GPU) in electronic device 112-1 may execute an application 612. This application may instruct 614 an image sensor 616 (such as a CMOS image sensor or a CCD sensor) in electronic device 112-1 to acquire one or more images 618, as a function of time, of a group of individuals in an environment (such as a physical environment or an environment associated with an application). Otherwise or additionally, the one or more images 618 may be accessed in memory 620 in electronic device 112-1. Then, application 612 may analyze the one or more images 618 to determine a dynamic attention or an indicia of an emotional state (DAIES) 622 of at least a subset of a group of individuals in the environment. Next, computation device 610 may instruct 624 an interface circuit 626 in electronic device to provide information 628 specifying the dynamic attention or the indicia of the emotional state 622 of the subset to computer system 130.

After receiving information 628, an interface circuit (IC) 630 in computer system 130 may provide information 628 to a computation device (CD) 632 (such as a processor and/or a GPU) in computer system 130. Then, computation device 632 may access additional data (AD) 636 in memory 634 in computer system 130. Note that additional data 636 may correspond to a second dynamically determined attention or a second indicia of an emotional state of at least a second subset of a second group of individuals. The second subset of the second group of individuals may have one or more common attributes as the subset of the group of individuals. For example, the subset and the second subset may have a common culture, such as social and/or demographic group, a country of origin or nationality, an ethnicity, a race, etc. In general, ‘culture’ may include ways of life, such as: arts, beliefs and institutions of a population that are passed down from generation to generation. ‘Culture’ may include codes of manners, dress, language, religion, rituals, art and ‘the way of life of a society.’ In some embodiments, additional data 636 may include historical data.

Moreover, computation device 632 may combine 638 or aggregate information 628 and additional data 636. For example, computation device 632 may combine 638 information 628 and additional data 636 to create a training dataset.

Next, computation device 632 may access predefined training preferences (PTP) 640 in memory 634. For example, predefined training preferences may include hyperparameters for training a neural network, such as: a type of stochastic gradient descent, a type of gradient, a batch size, a learning rate or a step size, a loss function, or a regularizing term in the loss function. Furthermore, computation device 632 determines a predictive model (PM) 642 based at least in part on information 628 and additional data 636, and the predefined training preferences 640.

In some embodiments, computation device 632 may store information specifying predictive model 642 in memory 632. Alternatively or additionally, computation device 632 may instruct 644 interface circuit 630 to provide information specifying predictive model 642 to electronic device 112-1. Application 612 may use predictive model 642 to determine a dynamic attention or an indicia of an emotional state of at least another subset of another group of individuals, such as during a conversation between two or more individuals, during a video conference or meeting, during interaction using a social-media application or platform, as part of a mental-health assessment (e.g., using a mental-health application), etc.

Note that, while FIGS. 5 and 6 illustrate computer system 130 training predictive model 642, in other embodiments predictive model 642 may, at least in part, be trained by electronic device 112-1. Thus, at least some of the operations in the insight discovery techniques may be implemented in a centralized and/or distributed manner. Moreover, in the insight discovery techniques, the learning (such as training of an updated version of the predictive model) may be automated, may be semi-automatic or may be manually controlled, e.g., by a user of the insight discovery techniques, an administrator of the insight discovery techniques and/or a moderator of the insight discovery techniques.

While FIGS. 4 and 6 illustrate communication between components using unidirectional or bidirectional communication with lines having single arrows or double arrows, in general the communication in a given operation in these figures may involve unidirectional or bidirectional communication. Moreover, at least some of the operations in FIGS. 4 and 6 may be performed sequentially or in parallel.

We now further describe uses of the insight discovery techniques. For example, the insight discovery techniques may be used to assess dynamic attention or an indicia of an emotional state of one or more individuals. FIG. 7 presents a drawing of a user interface 700 for a video-conferencing platform. This user interface may include information identifying identified or specified members of a subgroup 710. For example, the members of the subgroup may be predefined by a moderator of a video-conferencing meeting (such as an online classroom or a business meeting), and/or by the members themselves. Alternatively or additionally, a pretrained predictive model may identify the members of the subgroup (such as based at least in part on their behavior and actions during a video-conferencing meeting, e.g., the verbal and/or nonverbal communication by the participants in the video-conferencing meeting). In some embodiments, a video stream associated with the video-conferencing platform or application may be input to a pretrained predictive model (such as a pretrained neural network), which outputs indications (e.g., scores) for each of the participants in a video-conferencing meeting that indicate the subgroups (e.g., countries of origin, ethnicity, culture, etc.) to which these individuals belong. Note that in some embodiments, individuals in the video-conferencing meeting may be aggregated into subgroups using an unsupervised-learning technique, such as clustering based at least in part on their behavior and actions during the video-conferencing meeting.

Moreover, user interface 700 may indicate or specify dynamic attention or an indicia of an emotional state (DAIES) 714 of members of one or more subgroups. For example, user interface 700 may indicate when members of one or more subgroups are bored or inattentive 712, or experiencing a predicted emotion associated with anger, fear, sadness, distrust or enjoyment. For example, the behavior and actions of the members of a subgroup during a video-conferencing meeting may be input to a pretrained predictive model, which may output the dynamic attention or the indicia of the emotional state for the member(s) of the subgroup.

Note that the insight discovery techniques may be used in this manner to identify individual(s) who are attention or emotional outliers in a group of individuals, such as individual(s) that are more than 2 or 3 standard deviations from the mean attention or mean emotional state of the group of individuals (such as individual that is laughing at a funeral or crying at a birthday party).

Additionally, contextual insights can be used to group/subgroup (e.g., if you know it's a birthday party from cake, pinata, balloons, then you do not need to look to math (e.g., deviations from mean) to know that crying is an emotional outlier from the dynamic attention or an indicia of an emotional state (such as the dynamic attention or an indicia of an emotional state 714) in that context.

In some embodiments, user interface 700 may provide feedback 716 to a participant of a video-conferencing meeting based at least in part on the dynamic attention or the indicia of the emotional state of members of one or more subgroups. For example, feedback 716 may advise a speaker how to modify their behavior, actions or presented content (such as what the speaker is saying, how long they are talking, how fast they are talking, a presentation, etc.) during the video-conferencing meeting in order to change or modify the determined dynamic attention or the indicia of the emotional state of members of one or more subgroups.

FIG. 8 presents a drawing of a user interface 800 for a social-media application. Similar to the video-conferencing platform in FIG. 7, user interface 800 may indicate: identified or specified members of a subgroup 810; and/or dynamic attention 812 or an indicia of an emotional state (such as angry 814) of members of one or more subgroups. The indicia of emotional state (such as angry 814) may be used to determine metrics of social discourse, metrics of the ‘richness’ of discourse, and/or civility during interactions in the social-media application. In some embodiments, an administrator, group moderator, etc. may use various social incentives available within the social media application and/or priming cues to optimize constructive discourse (e.g., trending toward consensus, amicable compromise or conciliation, etc. as determined using, e.g., an LLM), rich understanding and connectedness, and/or civility.

Note that a social-media application may include an interactive technology that facilitates the creation, sharing and aggregation of content, ideas, interests, and other forms of expression in one or more virtual communities and/or networks. The social-media application may include: a blog, a business network, a collaborative project, an enterprise social network, a forum, a microblog, photograph sharing, a product/service review, social bookmarking, social gaming, social-networking websites, video sharing, and/or a virtual world.

FIG. 9 presents a drawing of a user interface 900 for a mental-health application. This user interface may provide information to a mental-health professional, such as a physician (e.g., a psychiatrist), a psychologist, a marriage and family therapist, a social worker, etc. Notably, the information may include: an identified or specified subgroup 910 to which an individual (such as patient or a counterparty in a discussion, e.g., a therapy session) belongs; and/or dynamic attention 912 and/or at least an indicia of an emotional state (such as sad 914, which may be displayed when a sadness metric exceeds a predefined threshold) of the individual. For example, the insight discovery techniques may be used to screen for depression during a medical appointment, a therapy session, and/or at another time (such as during the time between medical appointments).

FIG. 10 presents a drawing of a user interface 1000 associated with an electronic device. This user interface may be displayed or presented during an interaction between an individual and at least a second individual. For example, user interface 1000 may be displayed on a cellular telephone (e.g., a smartphone) of the individual or the second individual. More generally, user interface 1000 or information associated with user interface 1000 may be provided (e.g., visually or acoustically) using: a smart watch, smart glasses, an earpiece, headphones, etc. As in the previous embodiments, user interface 1000 may include: an identified or specified subgroup 1010 to which an individual (such as a counterparty in the discussion, e.g., the second individual) belongs; and/or a dynamic attention (such as attentive 1012) and/or an indicia of an emotional state (such as happy 1014) of the second individual.

Note that user interface 1000 may be used during a physical or direct interaction between two or more individuals. Alternatively or additionally, user interface 1000 may be used during a phone call between two or more individuals. In these embodiments, an application associated with user interface 1000 may be enabled by a user and/or the user may grant permission for the application to be used during a physical or a virtual interaction. More generally, the permission may be other than binary or yes/no. Instead, the permission may include or may specify different greyscale values for permissions associated with different individuals, different contexts (at work versus personal time), and/or different amounts of insight discovery or the types of information used during the insight discovery techniques (e.g., facial or personal identifying information may be excluded from use).

In some embodiments, user interface 700 (FIG. 7), user interface 800 (FIG. 8), user interface 900 (FIG. 9) and/or user interface 1000 include fewer or additional user-interface features. Moreover, two or more user-interface features may be combined into a single user-interface feature, and/or a single user-interface feature may be divided into two or more user-interface features. Furthermore, positions of one or more user-interface features may be changed. In some embodiments, a different type of user-interface feature may be used, such as a user-interface feature that provides information using a different format, such as auditory information, visual information and/or using another sense or type of perception.

In some embodiments, the insight discovery techniques may use a predictive model that is pretrained or predetermined using a machine-learning technique (such as a supervised learning technique, an unsupervised learning technique and/or a neural network) and a training dataset. For example, the predictive model may include a classifier or a regression model that was trained using: random forests, a support vector machine technique, a classification and regression tree technique, logistic regression, LASSO, linear regression, a neural network technique (such as deep learning, a convolutional neural network technique, an autoencoder neural network, a large language model or LLM, or another type of neural network technique), a boosting technique, a bagging technique, another ensemble learning technique and/or another linear or nonlinear supervised-learning technique. In the present discussion, note that ‘random forests' or random decision forests may include an ensemble learning technique for classification, regression and other tasks that operates by constructing a multitude of decision trees at training time. For classification tasks, the output of the random forest may be the class selected by most trees, while for regression tasks the mean or average prediction of the individual trees may be returned. Moreover, an ensemble learning technique may combine several decision trees classifiers to produce better predictive performance than a single decision tree classifier. In an ensemble model, a group of weak learners may be combined or aggregated to form a stronger learner, thereby increasing the accuracy of the model. Furthermore, bagging (or bootstrap aggregation) is a way to decrease the variance in a prediction by generating additional data for training from a dataset using combinations with repetitions to produce multiple subsets of the original data. Additionally, boosting is an iterative technique which adjusts the weight of an observation based on the last classification. If an observation was classified incorrectly, boosting tries to increase the weight of this observation in the subsequent model.

Moreover, the neural network may include or combine one or more convolutional layers, one or more residual layers and one or more dense or fully connected layers, and where a given node in a given layer in the given neural network may include an activation function, such as: a rectified linear activation function or ReLU, a leaky ReLU, an exponential linear unit or ELU activation function, a parametric ReLU, a tanh activation function, and/or a sigmoid activation function.

We now describe some embodiments of the insight discovery techniques. Shruti is a young professional Data Science engineer from India. She is extremely gifted and slightly autistic, but she is very naïve of US business culture. Before using the insight discovery techniques (which are sometimes referred to as ‘SocialQ’), Shruti (maybe in front of a chalkboard) develops a brilliant solution to her company's biggest current challenge. Her surroundings contain elements of Indian Culture to highlight her naivete with US culture.

She is asked to present her solution to a Boardroom full of American Businessmen. She gets physically intimidated about how close everyone is sitting together and that everyone touches her (shakes her hand). This highlights her native experience with a traditional greeting is the “Namaste,” where the palms are brought together at chest level with a slight bow, and her autistic profile of being sensitive to touch, fabrics, etc.

She presents her solution to the Businessmen. However, she does not recognize that when she highlighted the portion of the solution that makes the company money, a group of two men start acting excited and distracted: they begin laughing (in what she will later learn are laughs of joy about the prospect of making money, not laughs of ridicule at Shruti).

Socially unassisted, Shruti may get really creeped out by the handshakes and closeness (such as comfortability with physical touch and unlike her native greeting), and she may interpret the laughs as ridicule about her and her work.

Shruti may use a language application to learn English. The language application may include one or more application programming interfaces (APIs) with SocialQ. Now, while she is training with her English lessons, she is also learning about facial recognition and ‘normal’ US business customs (e.g. shaking hands and boisterous behavior, such as the mens' laughing). Shruti may put on glasses with a small camera and a smartwatch while she prepares for meeting. The glasses and/or the smartwatch may communicate with the SocialQ cloud.

After using SocialQ, Shruti may wear her smart glasses along with her traditional Indian business attire. An image sensor embedded in the glasses may scan the room. SocialQ may analyze the scene (such as detecting an American Boardroom, American businessmen, etc.), consult a model and/or a large language model, and interpret the context as a U.S. business meeting. Moreover, SocialQ may display a notification on her smart glasses relating to American Corporate handshaking culture and may prime her with calming, warm, vibrations from a smartwatch in anticipation of an environment that she may otherwise be uncomfortable in.

Next, while presenting her solution to the Businessmen, when she highlights the Value Proposition for the company in the presentation, she may receive an alert on the upper left portion of her smart glasses (indicating that the object(s) of the alert are far-away to the left). The alert may notify her that a subset of the group (at far left of the room) are becoming extremely excited. A deep-learning model may disambiguate the excitement as ‘joyful’ excitement as opposed to ‘bullying’ behavior (in what she will later learn are laughs of joy about the prospect of making money, not laughs of ridicule).

In another example, Quincy is a young (pre-k, kinder) child with moderate autism. He has trouble recognizing non-verbal communication cues.

Before using SocialQ: Socially unassisted, Quincy does not pick up on body language or situational context. Thus, he often become scared, nervous, and frustrated around kids his age. One day, Quincy is at a birthday party (cake, clown, pinata) and is hesitant to talk to anyone, not making eye contact, hypervigilant (e.g. looking around), wringing his hands, rocking while other groups of kids are smiling, laughing, etc. A young girl?(Carla) and a second child are also at the party, and they are in the corner by themselves crying.

Using SocialQ: Quincy sits at computer with his parent. The computer has a SocialQ website. Quincy logs into his SocialQ profile, scrolls a series of options, and checks a few options including ‘Difficultly with Non-Verbal Cues,’ ‘Requires Adequate Personal Space,’ and ‘Has Difficultly with Social Context.’

The computer and the cloud-based computer system associated with SocialQ may communicate with each other. They may also communicate with a smartwatch on his desk, a pair of smart glasses, a smartphone, etc.

Moreover, after using SocialQ: Quincy may wear his smart glasses and may walk into a similar party. His camera may scan the scene and may detect cake, clown and pinata. The smart glasses may communicate with the cloud-based computer system. The cloud-based computer system may determine the context that it is a birthday party. Then, cloud-based computer system may access Quincy's SocialQ profile and may provide Quincy personalized message based at least in part on his individual needs, e.g. age-appropriate audio/text (‘looks like a fun birthday party!’ or ‘most kids will want to make new friends at a party like this.’). Furthermore, the cloud-based computer system may detect face data/body language, etc. from participants from the scene.

Note that SocialQ may aggregate two people with threshold out of context reactions. Moreover, SocialQ may deliver relevant information to Quincy, such as: ‘??? Usually people do not cry at birthday parties???’ or ‘Those kids are not mad AT ME . . . ’ Additional information may be contextualized: ‘Maybe they are crying because a balloon popped near them two seconds ago’ The additional information may be given to Quincy: “Maybe they are crying because the balloon popping scared them. They are not scared of you!’

In a third example, after months of discovery, demonstrations, and scoping, a super star salesperson may finally get the opportunity to pitch their proposal to the stakeholders at Company X. The salesperson may present to ten people from Company X, two of whom hold the budget and decision-making power: the CFO and the Head of Procurement. SocialQ can interact via an API with a customer relationship management computer or data structure and determine the names of and profiles of the CFO and Head of Procurement. Once the salesperson gets to the pricing slide, she may receive an alert that the CFO and Head of Procurement may be cross-talking. The CFO may have rolled his eyes and in response the Head of Procurement may have rolled his eyes back and laughed. Because so many people are in the virtual meeting and she is focused on presenting the slide, the salesperson would usually not pick up on these non-verbal cues by these two stakeholders. However, she may be prompted by SocialQ that her two key stakeholders are not positively responding to her pricing slide. Consequently, she may quickly pivot to another slide (e.g., the Return on Investment or ROI and business case slide) to focus on the increased revenue that the company will capture in the next six months should they invest in and roll out her CRM solution. This quick pivot may draw the simultaneous attention of the CFO and Head of Procurement, and she may be notified or alerted by SocialQ that their non-verbal communication now indicates engagement and an intrigued demeanor. In some embodiments, this alert may be explicit and, in some cases, the alert may include a more-subtle priming cue, e.g. haptic pulses indicating a heightened heartbeat to indicate that she should keep emphasizing a point when the group's interest or the subset of the group's interest (e.g., CFO & Head of Procurement) is trending towards interested, engaged, excited, etc.

In a variation on this example, the subset of people may be the engineers responsible for implementing the solution. The engineers may share a look of confusion at a certain point in a sales pitch, and the saleswomen may be alerted so that she can pivot to the technical portions of the presentation in order to address the engineers' confusion.

In some embodiments, the insight discovery techniques may be used to combine groups of individuals and/or identify one or more subsets having dynamic attention or an indicia of an emotional state with a predicted confidence (such as 95%). For example, a subset A of individuals may appear (as measured by a threshold prediction certainty) to be expressing an emotion X (e.g., concern) in response to a user B having emotion Y (e.g., sad). Note that the insight discovery techniques may include correlated multiple insight information in time, e.g., ‘John looked ashamed at the same time Mary looked disappointed.’

Moreover, the insight discovery techniques may receive feedback from electronic devices associated with other users. For example, individuals X may look confused and, with a particular confidence factor (such as 85%), this may be because of out-of-context behavior by another individual. The out-of-context behavior may be determined from other sources in the environment, processed in a cloud-based computer system, and delivered back to an electronic device associated with a user. In this way, context may be correlated to events.

Furthermore, in some embodiments, the insight discovery techniques may provide suggestions in a social context (such as ‘you should apologize;), predictions (e.g., John is probably sad, Mary appeared to be happy recently and is now becoming confused), recommendations (e.g., in business environment, an API with customer relationship management information for local cohort data), etc. For example, a recommendation may help a salesperson ‘win the room’ (such as when the CFO and Head of Procurement of a customer look intrigued when a salesperson was presenting content about their company's value proposition).

In another embodiment, the insight discovery techniques may provide post-hoc focus grouping. For example, a subset X of a group may appear ‘intrigued’ when you mentioned ‘scalability’ in a presentation.

Alternatively, a user may add their own local cohort data, which may allow then to customize an output (e.g., ‘tell me whenever someone in my environment is express a threshold level of some dynamic attention or indicia of an emotional state). This may allow subjectively important cues to be stacked ranked.

In some embodiments, the insight discovery techniques may provide man-in-the-mirror training. For example, you may see a video of yourself as you respond to different prompts, and you may receive feedback as to whether or not your intended emotion matched your facial expression.

We now describe embodiments of an electronic device, which may perform at least some of the operations in the insight discovery techniques. FIG. 11 presents a block diagram illustrating an example of an electronic device 1100, e.g., one of electronic devices 112, one of access points 116, radio node 118, switch 128, and/or a computer or server in computer system 130, in accordance with some embodiments. For example, electronic device 1100 may include: processing subsystem 1110, memory subsystem 1112, and networking subsystem 1114. Processing subsystem 1110 includes one or more devices configured to perform computational operations. For example, processing subsystem 1110 can include one or more microprocessors, ASICs, microcontrollers, programmable-logic devices, GPUs and/or one or more DSPs. Note that a given component in processing subsystem 1110 are sometimes referred to as a ‘computation device’.

Memory subsystem 1112 includes one or more devices for storing data and/or instructions for processing subsystem 1110 and networking subsystem 1114. For example, memory subsystem 1112 can include dynamic random access memory (DRAM), static random access memory (SRAM), and/or other types of memory. In some embodiments, instructions for processing subsystem 1110 in memory subsystem 1112 include: program instructions or sets of instructions (such as program instructions 1122 or operating system 1124), which may be executed by processing subsystem 1110. Note that the one or more computer programs or program instructions may constitute a computer-program mechanism. Moreover, instructions in the various program instructions in memory subsystem 1112 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1110.

In addition, memory subsystem 1112 can include mechanisms for controlling access to the memory. In some embodiments, memory subsystem 1112 includes a memory hierarchy that comprises one or more caches coupled to a memory in electronic device 1100. In some of these embodiments, one or more of the caches is located in processing subsystem 1110.

In some embodiments, memory subsystem 1112 is coupled to one or more high-capacity mass-storage devices (not shown). For example, memory subsystem 1112 can be coupled to a magnetic or optical drive, a solid-state drive, or another type of mass-storage device. In these embodiments, memory subsystem 1112 can be used by electronic device 1100 as fast-access storage for often-used data, while the mass-storage device is used to store less frequently used data.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). (While FIG. 11 includes one or more antennas 1120, in some embodiments electronic device 1100 includes one or more nodes, such as antenna nodes 1108, e.g., a metal pad or a connector, which can be coupled to the one or more antennas 1120, or nodes 1106, which can be coupled to a wired or optical connection or link. Thus, electronic device 1100 may or may not include the one or more antennas 1120. Note that the one or more nodes 1106 and/or antenna nodes 1108 may constitute input(s) to and/or output(s) from electronic device 1100.) For example, networking subsystem 1114 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 1100 may use the mechanisms in networking subsystem 1114 for performing simple wireless communication between electronic devices, e.g., transmitting advertising or beacon frames and/or scanning for advertising frames transmitted by other electronic devices.

Within electronic device 1100, processing subsystem 1110, memory subsystem 1112, and networking subsystem 1114 are coupled together using bus 1128. Bus 1128 may include an electrical, optical, and/or electro-optical connection that the subsystems can use to communicate commands and data among one another. Although only one bus 1128 is shown for clarity, different embodiments can include a different number or configuration of electrical, optical, and/or electro-optical connections among the subsystems.

In some embodiments, electronic device 1100 includes a display subsystem 1126 for displaying information on a display, which may include a display driver and the display, such as a liquid-crystal display, a multi-touch touchscreen, etc. Moreover, electronic device 1100 may include a user-interface subsystem 1130, such as: a mouse, a keyboard, a trackpad, a stylus, a voice-recognition interface, and/or another human-machine interface.

Electronic device 1100 can be (or can be included in) any electronic device with at least one network interface. For example, electronic device 1100 can be (or can be included in): a desktop computer, a laptop computer, a subnotebook/netbook, a server, a supercomputer, a tablet computer, a smartphone, a smartwatch, a smart speaker, a cellular telephone, a consumer-electronic device, a wearable electronic device, an Internet-of-things device, a GPS device, a customer relationship management device, a brain-machine interface device, a portable computing device, communication equipment, and/or another electronic device.

Although specific components are used to describe electronic device 1100, in alternative embodiments, different components and/or subsystems may be present in electronic device 1100. For example, electronic device 1100 may include one or more additional processing subsystems, memory subsystems, networking subsystems, and/or display subsystems. Additionally, one or more of the subsystems may not be present in electronic device 1100. Moreover, in some embodiments, electronic device 1100 may include one or more additional subsystems that are not shown in FIG. 11. Also, although separate subsystems are shown in FIG. 11, in some embodiments some or all of a given subsystem or component can be integrated into one or more of the other subsystems or component(s) in electronic device 1100. For example, in some embodiments program instructions 1122 are included in operating system 1124 and/or control logic 1116 is included in interface circuit 1118.

Moreover, the circuits and components in electronic device 1100 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1114 and/or electronic device 1100. The integrated circuit may include hardware and/or software mechanisms that are used for transmitting signals from electronic device 1100 and receiving signals at electronic device 1100 from other electronic devices. Aside from the mechanisms herein described, radios are generally known in the art and hence are not described in detail. In general, networking subsystem 1114 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the insight discovery techniques may be implemented using program instructions 1122, operating system 1124 (such as a driver for interface circuit 1118) or in firmware in interface circuit 1118. Thus, the insight discovery techniques may be implemented at runtime of program instructions 1122. Alternatively or additionally, at least some of the operations in the insight discovery techniques may be implemented in a physical layer, such as hardware in interface circuit 1118.

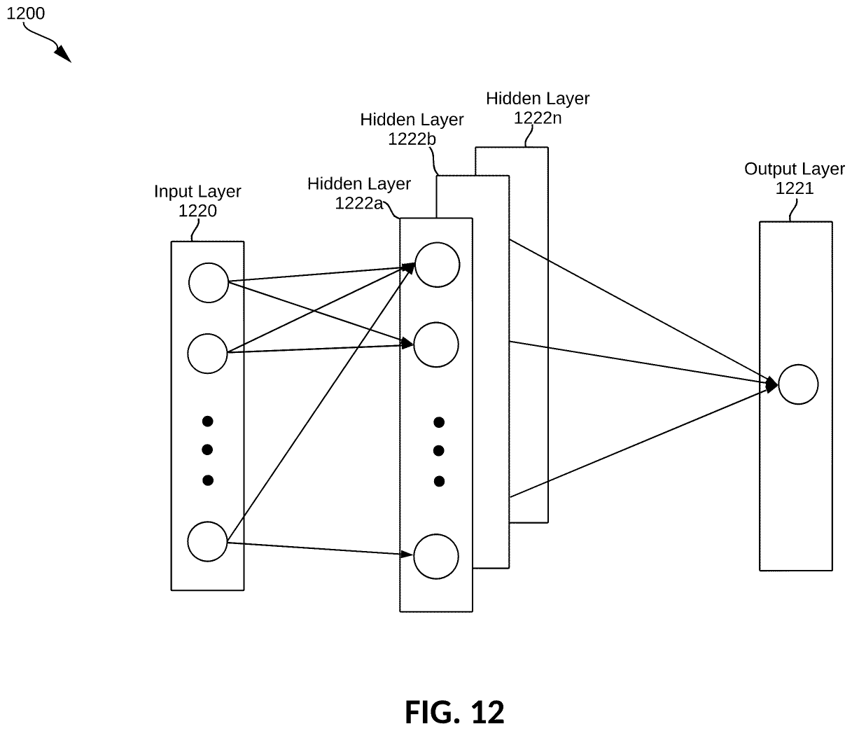

FIG. 12 is a diagram illustrating an example architecture 1200 of an example neural network, according to some aspects of the present disclosure. The example architecture 1200 can be used to implement any neural network described herein and/or any components described herein that may include or implement a neural network. For example, architecture 1200 can be used to implement a recommendation engine within a betting system that leverages social profile information, betting history data, and/or interaction patterns to generate personalized betting recommendations.

The architecture 1200 of neural network 1200 includes an input layer 1220 configured to receive and process data, which then generates one or more outputs. The architecture 1200 further includes multiple hidden layers, designated as 1222a, 1222b, through 1222n, where “n” represents an integer greater than or equal to one. This number of hidden layers can be adjusted based on the complexity and requirements of the application. Neural network 1200 also includes an output layer 1221 that produces the final output after processing data through the hidden layers 1222a, 1222b, through 1222n.

Neural network 1200 is a multi-layer neural network comprising interconnected nodes, with each node representing a unit of information. Data is shared across layers, with each layer retaining processed information as it moves forward through the network. Neural network 1200 can be implemented as a feed-forward network, which lacks feedback connections (where the network's outputs are not fed back into itself), or as a recurrent neural network (RNN), which includes loops that enable information to persist across nodes while new inputs are read.

Information flows between nodes via interconnections between various layers. Nodes in the input layer 1220 activate nodes in the first hidden layer 1222a. For example, each node in the input layer 1220 is connected to each node in the first hidden layer 1222a, which applies activation functions to the input data. This transformation results in new information that activates the nodes in the subsequent hidden layer, such as 1222b, where additional processing functions can be applied. These functions may include convolutional operations, up-sampling, data transformations, or other suitable processes. The transformed data from each hidden layer passes sequentially through all hidden layers until it reaches the final hidden layer 1222n, which activates the output layer 1221, producing the final output. While nodes in the network 1200 may appear to have multiple output connections, each node generally produces a single output, with multiple lines simply representing the propagation of this value to different layers or nodes.

Each node and interconnection in neural network 1200 is associated with a weight, a parameter set during the training phase. When neural network 1200 is trained, it becomes a “trained neural network” capable of generating outputs based on learned relationships. Interconnections between nodes store information about the relationships they represent, with each interconnection having a tunable weight. These weights are adjusted (e.g., using a training dataset), enabling neural network 1200 to adapt to new inputs and improve its accuracy as it processes more data. Neural network 1200 is pre-trained to process data features through the input layer 1220 and subsequent hidden layers 1222a, 1222b, through 1222n, to provide outputs via the output layer 1221.

In some aspects, neural network 1200 updates node weights through a training technique called backpropagation. This process includes a forward pass, computation of a loss function, a backward pass, and a weight update. Each training iteration involves these steps to adjust the network's parameters. This process is repeated for numerous training iterations until the weights across layers are optimally tuned, ensuring that neural network 1200 is trained accurately.

During training, a loss function is used to measure the error in the output, allowing the network to learn and minimize this error. Examples of loss functions include Cross-Entropy loss and Mean Squared Error (MSE), the latter defined as Etotal=Σ(½·(target−output)2). The goal is to minimize this loss function so that the predicted output aligns closely with the target values in the training data.

Initially, the loss (or error) is high due to the discrepancy between actual and predicted outputs. Through iterative adjustments, neural network 1200 minimizes the loss, achieving outputs that more accurately reflect the target data. During the backward pass, the network identifies which input weights most contributed to the error and adjusts these weights to progressively reduce the loss.

Neural network 1200 can incorporate various deep learning architectures. One example is a transformer network, often used for implementing large language models. Another example is a Convolutional Neural Network (CNN), which includes an input layer, an output layer, and multiple hidden layers consisting of convolutional, pooling, and fully connected layers. Other possible architectures for neural network 1200 include encoder-decoder networks, encoder-only networks, decoder-only networks, mixture of experts (MoE) networks, generative model networks, autoencoders, Deep Belief Networks (DBNs), and Recurrent Neural Networks (RNNs).

Those skilled in the art will recognize that machine-learning techniques may vary depending on implementation requirements. For example, machine learning schemes may utilize various models such as hidden Markov models, RNNs, CNNs, deep learning networks, Bayesian methods, Generative Adversarial Networks (GANs), support vector machines, image registration methods, and rule-based systems. Where regression is required, methods may include Stochastic Gradient Descent Regressor, Passive Aggressive Regressor, among others.

Machine learning classification models may also employ clustering algorithms (e.g., Mini-batch K-means clustering), recommendation algorithms (e.g., Minwise Hashing, Euclidean Locality-Sensitive Hashing), or anomaly detection algorithms (e.g., local outlier factor). Additionally, dimensionality reduction techniques, such as Mini-batch Dictionary Learning, incremental Principal Component Analysis (PCA), Latent Dirichlet Allocation, and Mini-batch K-means, may be applied to optimize data representation and model performance.

Aspects of the disclosed technology include:

Aspect 1. An electronic device, comprising: an interface circuit configured to communicate with a computer system; a computation device coupled to the interface circuit; and memory, coupled to the computation device, configured to store program instructions, wherein, when executed by the computation device, the program instructions cause the electronic device to perform operations comprising: receiving images of a group of individuals in an environment; dynamically determining attention or an indicium of an emotional state of individuals in the group of individuals based at least in part on nonverbal communication by the group of individuals in the images; dynamically aggregating a subset of the group of individuals having a particular determined attention or indicium; and providing information corresponding to the subset of the group of individuals having the particular determined attention or indicium.

Aspect 2. The electronic device of Aspect 1, wherein the instructions further cause the electronic device to perform operations for: identifying a culture of at least a subset of the group of individuals; and wherein the dynamic determined attention or emotional state is based at least in part on the identified culture.

Aspect 3. The electronic device of any of Aspects 1-2, wherein the instructions further cause the electronic device to perform operations for: identifying a second culture of at least a second subset of the group of individuals; and wherein the dynamic determined attention or emotional state is based at least in part on the identified second culture.

Aspect 4. The electronic device of any of Aspects 1 to 3, wherein a format of the information is based at least in part on the dynamically determined attention or the emotional state.

Aspect 5. The electronic device of any of Aspects 1 to 4, wherein different formats are used to provide information corresponding to different dynamically determined attention levels or different emotional states.

Aspect 6. The electronic device of any of Aspects 1 to 5, wherein the information comprises sampled data and associated timestamps; and wherein the sampled data corresponds to a dynamic change in the attention or emotional state of at least the subset of the group of individuals.

Aspect 7. The electronic device of any of Aspects 1 to 6, wherein the instructions further cause the electronic device to perform operations for: receiving, associated with a second electronic device, second information specifying boundaries of one or more aggregated subgroups, which comprise the aggregate subgroup.

Aspect 8. The electronic device of any of Aspects 1 to 7, wherein the instructions further cause the electronic device to perform operations for: providing, addressed to the second electronic device, suggestions for maximizing a criterion associated with the aggregated subgroup.

Aspect 9. The electronic device of any of Aspects 1 to 8, wherein the criterion a size of the aggregated subgroup, a consistency of the aggregated subgroup, a balance of the aggregated subgroup, or a combination thereof.

Aspect 10. The electronic device of any of Aspects 1 to 9, wherein the second information comprises selections from the provided suggestions.

Aspect 11. The electronic device of any of Aspects 1 to 10, wherein the suggestions comprise: a level of cross-talk among a certain number of individuals in at least a pair of aggregated subgroups, a threshold for a number of individuals in one or more of the aggregated subgroups appearing disappointed, or a combination thereof.

Aspect 12. The electronic device of any of Aspects 1 to 11, wherein the suggestions comprise suggestions for changing one or more of: tone, or content, to achieve a user-defined criterion.

Aspect 13. The electronic device of Aspects 1 to 12, wherein the suggestions comprise one or more of: a remedial action to achieve a user-defined maximization criterion, or a remedial action to modify the dynamically determined attention or indicium.

Aspect 14. The electronic device of any of Aspects 1 to 13, wherein the information comprises one or more of: a context associated with the dynamically determined attention, or a context associated with the emotional state.

Aspect 15. The electronic device of any of Aspects 1 to 14, wherein the information comprises directional information.

Aspect 16. A non-transitory computer-readable storage medium for use in conjunction with an electronic device, the computer-readable storage medium configured to store program instructions that, when executed by the electronic device, causes the electronic device to perform one or more operations comprising: receiving images of a group of individuals in an environment; dynamically determining attention or an indicium of an emotional state of individuals in the group of individuals based at least in part on nonverbal communication by the group of individuals in the images; dynamically aggregating a subset of the group of individuals having a particular determined attention or indicium; and providing information corresponding to the subset of the group of individuals having the particular determined attention or indicium.

Aspect 17. The non-transitory computer-readable storage medium of Aspect 16, wherein the program instructions are further configured to cause the electronic device to perform one or more operations comprising: identifying a culture of at least a subset of the group of individuals; and wherein the dynamic determined attention or emotional state is based at least in part on the identified culture.

Aspect 18. A method for providing information, comprising: receiving images of a group of individuals in an environment; dynamically determining attention or an indicium of an emotional state of individuals in the group of individuals based at least in part on nonverbal communication by the group of individuals in the images; dynamically aggregating a subset of the group of individuals having a particular determined attention or indicium; and providing the information corresponding to the subset of the group of individuals having the particular determined attention or indicium.

Aspect 19. The method of Aspect 18, further comprising: identifying a culture of at least a subset of the group of individuals; and wherein the dynamic determined attention or emotional state is based at least in part on the identified culture.

Aspect 20. The method of any of Aspects 18 to 19, wherein a format of the information is based at least in part on the dynamically determined attention or the emotional state.

Aspect 21. The method of any of Aspects 18 to 20, wherein the dynamically determined attention or indicium of an emotional state is refined using a predictive model trained on historical data associated with a cohort having similar neurodiverse profiles.

Aspect 22. The method of any of Aspects 18 to 21, further comprising: adjusting the format of the provided information based on user-defined preferences, wherein the format includes visual indicators, auditory signals, haptic feedback, or a combination thereof.

Aspect 23. The method of any of Aspects 18 to 22, further comprising: aggregating the subset of individuals using clustering techniques based on a threshold similarity in nonverbal communication patterns.

Aspect 24. The method of any of Aspects 18 to 23, further comprising: accessing a stored cognitive profile of a user; and modifying an analysis of nonverbal communication based on the user's neurocognitive characteristics.

Aspect 25. The method of any of Aspects 18 to 24, further comprising: determining contextual information from the images, including environmental factors including one or more of: lighting conditions, physical proximity of individuals, and presence of objects indicative of a specific event.

Aspect 26. The method of any of Aspects 18 to 25, further comprising: detecting temporal patterns in the emotional state of the group; and providing a trend analysis based on the detected temporal patterns.

Aspect 27. The method of any of Aspects 18 to 26, further comprising: filtering detected emotional states based on cultural context.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the insight discovery techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a computer system;
a computation device coupled to the interface circuit; and
memory, coupled to the computation device, configured to store program instructions, wherein, when executed by the computation device, the program instructions cause the electronic device to perform operations comprising:
receiving images of a group of individuals in an environment;
dynamically determining attention or an indicium of an emotional state of individuals in the group of individuals based at least in part on nonverbal communication by the group of individuals in the images;
dynamically aggregating a subset of the group of individuals having a particular determined attention or indicium; and
providing information corresponding to the subset of the group of individuals having the particular determined attention or indicium.

2. The electronic device of claim 1, wherein the instructions further cause the electronic device to perform operations for:
identifying a culture of at least a subset of the group of individuals; and
wherein the dynamic determined attention or emotional state is based at least in part on the identified culture.

3. The electronic device of claim 2, wherein the instructions further cause the electronic device to perform operations for:
identifying a second culture of at least a second subset of the group of individuals; and
wherein the dynamic determined attention or emotional state is based at least in part on the identified second culture.

4. The electronic device of claim 1, wherein a format of the information is based at least in part on the dynamically determined attention or the emotional state.

5. The electronic device of claim 4, wherein different formats are used to provide information corresponding to different dynamically determined attention levels or different emotional states.

6. The electronic device of claim 1, wherein the information comprises sampled data and associated timestamps; and
wherein the sampled data corresponds to a dynamic change in the attention or emotional state of at least the subset of the group of individuals.

7. The electronic device of claim 1, wherein the instructions further cause the electronic device to perform operations for:
receiving, associated with a second electronic device, second information specifying boundaries of one or more aggregated subgroups, which comprise the aggregate subgroup.

8. The electronic device of claim 7, wherein the instructions further cause the electronic device to perform operations for:
providing, addressed to the second electronic device, suggestions for maximizing a criterion associated with the aggregated subgroup.

9. The electronic device of claim 8, wherein the criterion a size of the aggregated subgroup, a consistency of the aggregated subgroup, a balance of the aggregated subgroup, or a combination thereof.

10. The electronic device of claim 8, wherein the second information comprises selections from the provided suggestions.

11. The electronic device of claim 7, wherein the suggestions comprise: a level of cross-talk among a certain number of individuals in at least a pair of aggregated subgroups, a threshold for a number of individuals in one or more of the aggregated subgroups appearing disappointed, or a combination thereof.

12. The electronic device of claim 7, wherein the suggestions comprise suggestions for changing one or more of: tone, or content, to achieve a user-defined criterion.

13. The electronic device of claim 12, wherein the suggestions comprise one or more of: a remedial action to achieve a user-defined maximization criterion, or a remedial action to modify the dynamically determined attention or indicium.

14. The electronic device of claim 1, wherein the information comprises one or more of: a context associated with the dynamically determined attention, or a context associated with the emotional state.

15. The electronic device of claim 1, wherein the information comprises directional information.

16. A non-transitory computer-readable storage medium for use in conjunction with an electronic device, the computer-readable storage medium configured to store program instructions that, when executed by the electronic device, causes the electronic device to perform one or more operations comprising:
receiving images of a group of individuals in an environment;
dynamically determining attention or an indicium of an emotional state of individuals in the group of individuals based at least in part on nonverbal communication by the group of individuals in the images;
dynamically aggregating a subset of the group of individuals having a particular determined attention or indicium; and
providing information corresponding to the subset of the group of individuals having the particular determined attention or indicium.

17. The non-transitory computer-readable storage medium of claim 16, wherein the program instructions are further configured to cause the electronic device to perform one or more operations comprising:
identifying a culture of at least a subset of the group of individuals; and
wherein the dynamic determined attention or emotional state is based at least in part on the identified culture.

18. A method for providing information, comprising:
receiving images of a group of individuals in an environment;
dynamically determining attention or an indicium of an emotional state of individuals in the group of individuals based at least in part on nonverbal communication by the group of individuals in the images;
dynamically aggregating a subset of the group of individuals having a particular determined attention or indicium; and
providing the information corresponding to the subset of the group of individuals having the particular determined attention or indicium.

19. The method of claim 18, further comprising:
identifying a culture of at least a subset of the group of individuals; and
wherein the dynamic determined attention or emotional state is based at least in part on the identified culture.

20. The method of claim 18, wherein a format of the information is based at least in part on the dynamically determined attention or the emotional state.
